(19) United States
(12) Patent Application Publication
(10) Pub. No.: US 2024/0393501 A1
(43) Pub. Date: Nov. 28, 2024

(54) COATED SILICONE HYDROGEL CONTACT LENSES AND METHOD FOR MAKING THE SAME

(71) Applicant: Alcon Inc., Fribourg (CH)

(72) Inventors: Jack W. Trieu, Atlanta, GA (US); Daqing Wu, Suwanee, GA (US); Feng Jing, Alpharetta, GA (US); Steve Yun Zhang, Sugar Hill, GA (US)

(21) Appl. No.: 18/670,852

(22) Filed: May 22, 2024

Related U.S. Application Data
(60) Provisional application No. 63/504,308, filed on May 25, 2023.

(51) Int. Cl. G02B 1/04; C07F 5/02; G02B 1/10

(52) U.S. Cl. CPC G02B 1/043; C07F 5/025; G02B 1/10

(57) ABSTRACT

The invention provides a method for producing coated silicone hydrogel contact lenses in a cost-effective manner. The method comprises obtaining a preformed silicone hydrogel contact lens comprising a bulk silicone hydrogel material that comprises repeating units of at least one carboxyl-containing vinylic monomer and at least one arylborono-containing vinylic monomer, and heating the preformed silicone hydrogel contact lens in an aqueous coating solution comprising a water-soluble and thermally crosslinkable polymeric material having azetidinium or epoxide groups and a diol-containing hydrophilic polymer having 1,2- or 1,3-diol moieties to form a coated silicone hydrogel contact lens comprising a bulk silicone hydrogel material and a hydrogel coating that comprises a crosslinked polymeric material covalently attached onto the bulk silicone hydrogel material and a grafted diol-containing hydrophilic polymer covalently attached onto the bulk silicone hydrogel material and distributed in the crosslinked polymeric material.

This application claims the benefit under 35 USC § 119 (e) of U.S. provisional application No. 63/504,308 filed 25 May 2023, herein incorporated by reference in its entirety.

The present invention is related to a method for producing coated silicone hydrogel contact lenses in a cost-effective and environmentally friendly manner. The present invention is also related to coated silicone hydrogel contact lenses made according to a method of the invention.

### BACKGROUND

A new class of soft contact lenses, water gradient silicone hydrogel contact lenses, e.g., DAILIES® TOTAL1® (Alcon), PRECISION1® (Alcon), and TOTAL30® (Alcon), have been developed and successfully introduced in the market. This new class of soft contact lenses is characterized by having a water-gradient structural configuration, an increase in water content from 33% to over 80% from core to surface (see, e.g., U.S. Pat. Nos. 8,480,227, 11,061,168, and 11256003). This class of water-gradient silicone hydrogel contact lenses can provide superior wearing comfort to patients due to their extremely-soft, water-rich, relatively-thick, and lubricious hydrogel coatings.

As described in U.S. Pat. No. 8,480,227 and U.S. Ser. No. 11/256,003, processes for making water gradient contact lenses often involve forming non-silicone hydrogel coatings on contact lenses which have either a base coating having reactive functional groups (e.g., carboxylic acid groups) or is made of a silicone hydrogel material having reactive functional groups (e.g., carboxylic acid groups). Where a reactive base coating is required, a method for producing water gradient contact lenses may require an extra step for forming the reactive base coating. Where the silicone hydrogel material of a contact lens has reactive functional groups (e.g., carboxylic acid groups), such silicone hydrogel contact lenses could be susceptible to degradation due to the higher amount of carboxylic acid groups present in the silicone hydrogel contact lens. But, reducing carboxylic acid content may improve lens shelf life whereas the coating uniformity may be compromise.

Therefore, it would be desirable to develop a new process for forming uniform non-silicone hydrogel coatings while maintaining low acid content in silicone hydrogel lens materials in the production of water gradient contact lenses.

### SUMMARY OF THE INVENTION

The present invention, in one aspect, provides a method for producing coated silicone hydrogel contact lenses, comprising the steps of: (1) obtaining a preformed silicone hydrogel contact lens, wherein the preformed hydrogel contact lens comprises a bulk silicone hydrogel material that comprises (a) repeating units of at least one polysiloxane vinylic crosslinker and/or at least one siloxane-containing vinylic monomer, (b) from about 0.5% to about 3.5% by weight of repeating units of at least one carboxyl-containing vinylic monomer relative to the total amount of all polymerizable components, (c) repeating units of at least one hydrophilic vinylic monomer, (d) from about 2.5% to about 12.5% by weight of repeating units of at least one arylborono-containing vinylic monomer having an arylborono group; (e) optionally but preferably at least one non-silicone vinylic crosslinker; and (2) heating the preformed silicone hydrogel contact lens in an aqueous coating solution at a temperature from about 60° C. to about 140° C. to form a coated silicone hydrogel contact lens comprising the bulk silicone hydrogel material and a non-silicone hydrogel coating thereon, wherein the aqueous coating solution comprises (a) at least one diol-containing hydrophilic polymer having 1,2- and/or 1,3-diol moieties and (b) at least one water-soluble, thermally-crosslinkable hydrophilic polymeric material that is branched or slightly-crosslinked and comprises thermally crosslinkable groups and optionally reactive functional groups, wherein the thermally crosslinkable group are azetidinium groups and/or epoxide groups, wherein the reactive functional groups are primary amino groups, secondary amino groups, carboxylic acid groups, thiol groups, or combinations thereof, wherein the non-silicone hydrogel coating comprises a crosslinked polymeric material and a grafted hydrophilic polymer, wherein the crosslinked hydrophilic polymeric material is derived from said at least one water-soluble, thermally-crosslinkable hydrophilic polymeric material and is covalently attached to the bulk silicone hydrogel material through first linkages each formed between one carboxylic acid group and one azetidinium or epoxide group, wherein the grafted hydrophilic polymer is derived from said at least one diol-containing hydrophilic polymer and is covalently attached to the bulk silicone hydrogel material through second linkages each formed between one arylboronoc group and one 1,2- or 1,3-diol moiety.

The present invention, in another aspect, provides a coated silicone hydrogel contact lens comprising a bulk silicone hydrogel material and a non-silicone hydrogel coating thereon, wherein the bulk silicone hydrogel material comprises (a) repeating units of at least one polysiloxane vinylic crosslinker and/or at least one siloxane-containing vinylic monomer, (b) repeating units of at least one carboxyl-containing vinylic monomer relative to the total amount of all polymerizable components, (c) repeating units of at least one hydrophilic vinylic monomer, (d) repeating units of at least one arylborono-containing vinylic monomer having an arylborono group; (e) optionally but preferably repeating units of at least one non-silicone vinylic crosslinker, wherein the non-silicone hydrogel coating comprises a crosslinked polymeric material and a grafted diol-containing hydrophilic polymer that is distributed in but not covalently bonded to the crosslinked polymeric material, wherein the crosslinked hydrophilic polymeric material is covalently attached to the bulk silicone hydrogel material through first linkages each formed between one carboxylic acid group and one azetidinium or epoxide group, wherein the grafted diol-containing hydrophilic polymer comprises 1,2- and/or 1,3-diol moieties and is covalently attached to the bulk silicone hydrogel material through second linkages each formed between one arylboronoc group and one 1,2- or 1,3-diol moiety, wherein the coated silicone hydrogel contact lens in fully hydrated state exhibits a coating intactness of about 90% or higher and a friction rating of about 2.0 or lower.

### DETAILED DESCRIPTION OF EMBODIMENTS OF THE INVENTION

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well known and commonly employed in the art.

“About” as used herein in this application means that a number, which is referred to as “about”, comprises the recited number plus or minus 1-10% of that recited number.

“Contact Lens” refers to a structure that can be placed on or within a wearer's eye. A contact lens can correct, improve, or alter a user's eyesight, but that need not be the case.

A “hydrogel contact lens” refers to a contact lens comprising a hydrogel bulk (core) material. A hydrogel bulk material can be a non-silicone hydrogel material or preferably a silicone hydrogel material.

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated).

A “silicone hydrogel” or “SiHy” refers to a silicone-containing hydrogel obtained by copolymerization of a polymerizable composition comprising at least one silicone-containing monomer or at least one silicone-containing macromer or at least one crosslinkable silicone-containing prepolymer.

A siloxane, which often also described as a silicone, refers to a molecule having at least one moiety of —Si—O—Si— where each Si atom carries two organic groups as substituents.

As used in this application, the term “non-silicone hydrogel” or “non-silicone hydrogel material” interchangeably refers to a hydrogel that is theoretically free of silicon.

“Hydrophilic,” as used herein, describes a material or portion thereof that will more readily associate with water than with lipids.

The term “room temperature” refers to a temperature of about 17° C. to about 26° C.

The term “soluble”, in reference to a compound or material in a solvent, means that the compound or material can be dissolved in the solvent to give a solution with a concentration of at least about 0.5% by weight at room temperature.

The term “insoluble”, in reference to a compound or material in a solvent, means that the compound or material can be dissolved in the solvent to give a solution with a concentration of less than 0.01% by weight at room temperature (as defined above).

A “vinylic monomer” refers to a compound that has one sole ethylenically unsaturated group, is soluble in a solvent, and can be polymerized actinically or thermally.

The term “olefinically unsaturated group” or “ethylenically unsaturated group” is employed herein in a broad sense and is intended to encompass any groups containing at least one >C═CH₂ group. Exemplary ethylenically unsaturated groups include without limitation (meth)acryloyl

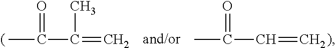

allyl, vinyl, styrenyl, or other C═CH₂ containing groups.

An “acrylic monomer” refers to a vinylic monomer having one sole (meth)acryloyl group. Examples of acrylic monomers includes (meth)acryloxy [or (meth)acryloyloxy] monomers and (meth)acrylamido monomers.

An “(meth)acryloxy monomer” or “(meth)acryloyloxy monomer” refers to a vinylic monomer having one sole group of

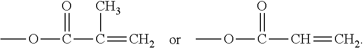

An “(meth)acrylamido monomer” refers to a vinylic monomer having one sole group of

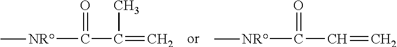

R^{o} is H or C₁-C₄ alkyl.

The term “(meth)acrylamide” refers to methacrylamide and/or acrylamide.

The term “(meth)acrylate” refers to methacrylate and/or acrylate.

An “N-vinyl amide monomer” refers to an amide compound having a vinyl group (—CH═CH₂) that is directly attached to the nitrogen atom of the amide group.

An “ene monomer” refers to a vinylic monomer having one sole ene group.

A “hydrophilic vinylic monomer”, a “hydrophilic acrylic monomer”, a “hydrophilic (meth)acryloxy monomer”, or a “hydrophilic (meth)acrylamido monomer”, as used herein, respectively refers to a vinylic monomer, an acrylic monomer, a (meth)acryloxy monomer, or a (meth)acrylamido monomer), which typically yields a homopolymer that is water-soluble or can absorb at least 10 percent by weight of water.

A “hydrophobic vinylic monomer”, a “hydrophobic acrylic monomer”, a “hydrophobic (meth)acryloxy monomer”, or a “hydrophobic (meth)acrylamido monomer”, as used herein, respectively refers to a vinylic monomer, an acrylic monomer, a (meth)acryloxy monomer, or a (meth)acrylamido monomer), which typically yields a homopolymer that is insoluble in water and can absorb less than 10% by weight of water.

In this application, an “arylborono-containing vinylic monomer” refers to a vinylic monomer which comprises one sole arylborono group linked to its sole ethylenically unsaturated group through one linkage.

In this application, an “arylborono” group refers to a monovalent radical o

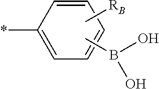

in which R_{B} is a monovalent radical (preferably H, NO₂, F, Cl, Br, CF₃, CH₂OH, or CH₂NR^{o}R^{o′} in which R^{o} and R^{o′} independent of each other are H or C₁-C₄ alkyl). It is understood that where R_{B} is CH₂OH, or CH₂NR^{o}R^{o′}, it is at the ortho-position of the boronic acid and can form intramolecular B—O or B—N coordination to lower the pKa of the boronic acid.

As used in this application, the term “vinylic crosslinker” refers to an organic compound having at least two ethylenically unsaturated groups. A “vinylic crosslinking agent” refers to a vinylic crosslinker having a molecular weight of 700 Daltons or less.

An “acrylic crosslinker” refers to a vinylic crosslinker having at least two (meth)acryloyl groups.

The term “acrylic repeating units” refers to repeating units of a polymeric material, each of which is derived from an acrylic monomer or crosslinker in a free-radical polymerization to form the polymeric material.

The term “terminal (meth)acryloyl group” refers to one (meth)acryloyl group at one of the two ends of the main chain (or backbone) of an organic compound.

As used herein, “actinically” in reference to curing, crosslinking or polymerizing of a polymerizable composition, a prepolymer or a material means that the curing (e.g., crosslinked and/or polymerized) is performed by actinic irradiation, such as, for example, UV/visible irradiation, ionizing radiation (e.g., gamma ray or X-ray irradiation), microwave irradiation, and the like. Thermal curing or actinic curing methods are well-known to a person skilled in the art.

As used in this application, the term “polymer” means a material formed by polymerizing or crosslinking one or more monomers or macromers or prepolymers or combinations thereof.

A “macromer” or “prepolymer” refers to a compound or polymer that has ethylenically unsaturated groups and a number average molecular weight of greater than 700 Daltons.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatochraphy) with one or more of a refractive index detector, a low-angle laser light scattering detector, a multi-angle laser light scattering detector, a differential viscometry detector, a UV detector, and an infrared (IR) detector; MALDI-TOF MS (matrix-assisted desorption/ionization time-of-flight mass spectroscopy); ¹H NMR (Proton nuclear magnetic resonance) spectroscopy, etc.

A “polysiloxane segment” or “polydiorganosiloxane segment” interchangeably refers to a polymer chain segment (i.e., a divalent radical) of

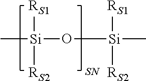

in which SN is an integer of 3 or larger and each of R_{S1}, and R_{S2} independent of one another are selected from the group consisting of: C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₁₈ alkyl; -alk-(OC₂H₄)_{γ1}—OR^{o} (in which alk is C₁-C₆ alkylene diradical, R^{o} is H or C₁-C₄ alkyl and γ1 is an integer from 1 to 10); a C₂-C₄₀ organic radical having at least one functional group selected from the group consisting of hydroxyl group (—OH), carboxyl group (—COOH), amino group (—NR_{N1}R_{N1}′), amino linkages of —NR_{N1}—, amide linkages of —CONR_{N1}—, amide of —CONR_{N1}R_{N1}′, urethane linkages of —OCONH—, and C₁-C₄ alkoxy group, or a linear hydrophilic polymer chain, in which R_{N1} and R_{N1}′ independent of each other are hydrogen or a C₁-C₁₅ alkyl.

A “polysiloxane vinylic monomer” refers to a compound comprising at least one polysiloxane segment and one sole ethylenically-unsaturated group.

A “polydiorganosiloxane vinylic crosslinker” or polysiloxane vinylic crosslinker” interchangeably refers to a compound comprising at least one polysiloxane segment and at least two ethylenically-unsaturated groups.

A “linear polydiorganosiloxane vinylic crosslinker” or “linear polysiloxane vinylic crosslinker” interchangeably refers to a compound comprising a main chain which includes at least one polysiloxane segment and is terminated with one ethylenically-unsaturated group at each of the two ends of the main chain.

A “chain-extended polydiorganosiloxane vinylic crosslinker” or “chain-extended polysiloxane vinylic crosslinker” interchangeably refers to a compound comprising at least two ethylenically-unsaturated groups and at least two polysiloxane segments each pair of which are linked by one divalent radical.

The term “fluid” as used herein indicates that a material is capable of flowing like a liquid.

As used in this application, the term “optically clear” in reference to a polymerizable composition means that the polymerizable composition is a transparent solution or liquid mixture (i.e., having a light transmissibility of 85% or greater, preferably 90% or greater in the range between 400 to 700 nm).

The term “monovalent radical” refers to an organic radical that is obtained by removing a hydrogen atom from an organic compound and that forms one bond with one other group in an organic compound. Examples include without limitation, alkyl (by removal of a hydrogen atom from an alkane), alkoxy (or alkoxyl) (by removal of one hydrogen atom from the hydroxyl group of an alkyl alcohol), thiyl (by removal of one hydrogen atom from the thiol group of an alkylthiol), cycloalkyl (by removal of a hydrogen atom from a cycloalkane), cycloheteroalkyl (by removal of a hydrogen atom from a cycloheteroalkane), aryl (by removal of a hydrogen atom from an aromatic ring of the aromatic hydrocarbon), heteroaryl (by removal of a hydrogen atom from any ring atom), amino (by removal of one hydrogen atom from an amine), etc.

The term “divalent radical” refers to an organic radical that is obtained by removing two hydrogen atoms from an organic compound and that forms two bonds with other two groups in an organic compound. For example, an alkylene divalent radical (i.e., alkylenyl) is obtained by removal of two hydrogen atoms from an alkane, a cycloalkylene divalent radical (i.e., cycloalkylenyl) is obtained by removal of two hydrogen atoms from the cyclic ring.

In this application, the term “substituted” in reference to an alkyl or an alkylenyl means that the alkyl or the alkylenyl comprises at least one substituent which replaces one hydrogen atom of the alkyl or the alkylenyl and is selected from the group consisting of hydroxyl {—OH), carboxyl (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, and combinations thereof.

In this application, the term “polyoxazoline” refers to a polymer or polymer segment of

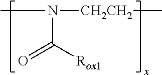

in which: Rₒₓ₁ is hydrogen, methyl, ethyl, N-pyrrolidonylmethyl, N-pyrrolidonylethyl, N-pyrrolidonylpropyl, or a monovalent radical of -alk-(OC₂H₄)ₘ₃—OR″ in which alk is C₁-C₄ alkyl diradical; R″ is C₁-C₄ alkyl (preferably methyl); m3 is an integer from 1 to 10 (preferably 1 to 5); x is an integer from 5 to 500.

In this application, the term “poly(2-oxazoline-co-ethyleneimine)” refers to a statistical copolymer or a polymer segment thereof having a formula of

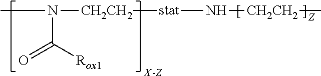

in which: Rₒₓ₁ is hydrogen, methyl, ethyl, N-pyrrolidonylmethyl, N-pyrrolidonylethyl, N-pyrrolidonylpropyl, or a monovalent radical of -alk-(OC₂H₄)ₘ₃—OR″ in which alk is C₁-C₆ alkyl diradical; R″ is C₁-C₄ alkyl (preferably methyl); m3 is an integer from 1 to 10 (preferably 1 to 5); x is an integer from 5 to 500; z is an integer equal to or less than x. A poly(2-oxazoline-co-ethyleneimine) is obtained by hydrolyzing a polyoxazoline.

In this application, the term “poly(2-oxazoline-co-ethyleneimine)-epichlorohydrin” refers to a polymer obtained by reacting a poly(2-oxazoline-co-ethyleneimine) with epichlorohydrin to convert all or substantial percentage (>90%) of the secondary amine groups of the poly(2-oxazoline-co-ethyleneimine) into azetidinium groups. Examples of poly(2-oxazoline-co-ethyleneimine)-epichlorohydrin are disclosed in U.S. pat. Appl. No. 2016/0061995A1.

An “epichlorohydrin-functionalized polyamine” or “epichlorohydrin-functionalized polyamidoamine” refers to a polymer obtained by reacting a polyamine or polyamidoamine with epichlorohydrin to convert all or a substantial percentage of the secondary amine groups of the polyamine or polyamidoamine into azetidinium groups.

The term “polyamidoamine-epichlorohydrin” refers to an epichlorohydrin-functionalized adipic acid-diethylenetriamine copolymer.

In this application the term “azetidinium” or “3-hydroxyazetidinium” refers to a positively-charged (i.e., cationic), divalent radical (or group or moiety) of

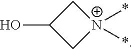

The term “thermally-crosslinkable” in reference to a polymeric material or a functional group means that the polymeric material or the functional group can undergo a crosslinking (or coupling) reaction with another material or functional group at a relatively-elevated temperature (from about 40° C. to about 140° C.), whereas the polymeric material or functional group cannot undergo the same crosslinking reaction (or coupling reaction) with another material or functional group at a temperature of from about 5° C. to about 15° C., to an extend detectable for a period of about one hour.

As used in this application, the term “phosphorylcholine” refers to a zwitterionic group of

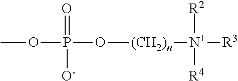

in which n is an integer of 1 to 5 and R², R³ and R⁴ independently of each other are C₁-C₈ alkyl or C₁-C₈ hydroxyalkyl.

As used in this application, the term “reactive vinylic monomer” refers to any vinylic monomer having at least one reactive functional group selected from the group consisting of carboxyl group, primary amino group, and secondary amino group.

As used in this application, the term “non-reactive vinylic monomer” refers to any vinylic monomer (either hydrophilic or hydrophobic vinylic monomer) free of carboxyl group, primary amino group, secondary amino group, epoxide group, isocyanate group, azlactone group, or aziridine group.

A free radical initiator can be either a photoinitiator or a thermal initiator. A “photoinitiator” refers to a chemical that initiates free radical crosslinking/polymerizing reaction by the use of light. A “thermal initiator” refers to a chemical that initiates free radical crosslinking/polymerizing reaction by the use of heat energy.

As used in this application, the term “bulk silicone hydrogel material” in reference to a contact lens interchangeably means a layer of the silicone hydrogel material that has substantially the 3-dimensional shape of the contact lens.

The intrinsic “oxygen permeability”, Dkᵢ, of a material is the rate at which oxygen will pass through a material. Oxygen permeability is conventionally expressed in units of barrers, where “barrer” is defined as [(cm³ oxygen)(mm)/(cm²)(sec)(mm Hg)]×10⁻¹⁰.

The “oxygen transmissibility”, Dk/t, of an insert or material is the rate at which oxygen will pass through a specific insert or material with an average thickness of t [in units of mm] over the area being measured. Oxygen transmissibility is conventionally expressed in units of barrers/mm, where “barrers/mm” is defined as [(cm³ oxygen)/(cm²)(sec)(mm Hg)]×10⁻⁹.

The term “modulus” or “elastic modulus” in reference to a contact lens or a material means the tensile modulus or Young's modulus which is a measure of the stiffness of a contact lens or a material.

The term “dry lens precursor” refers to a cast-molded contact lens that is obtained by cast-molding of a polymerizable composition in a mold and has not been subjected to extraction and/or hydration post-molding processes (i.e., having not been in contact with water or any organic solvent or any liquid after molding).

The term “a wettable silicone hydroge contact lens” means that the silicone hydrogel contact lens has a water-break-up-time (“WBUT”) of at least 10 seconds, preferably at least 15 seconds, more preferably at least 20 seconds, even more preferably at least 25 seconds. WBUT can be measured according to the procedures described in Example 1.

The term “an optically-clear silicone hydrogel contact lens” means that the silicone hydrogel contact lens has a light transmissibility of at least 85%, preferably at least 90%, more preferably at least 93%, even more preferably at least 95% in the range from 400 to 700 nm. The light transmissibility of a contact lens in the range from 400 to 700 nm can be measured according to the procedures described in Example 1.

An “average water contact angle” refers to a water contact angle (measured by Sessile Drop), which is obtained by averaging measurements of at least 3 individual contact lenses or samples of a silicone hydrogel material.

In general, the invention is directed to a method for producing coated SiHy contact lenses each having a non-silicone hydrogel coating thereon in a cost-effective manner. The invention is based partly on the discovery that preformed SiHy contact lenses having two types of reactive functional groups (carboxylic acid groups and arylborono groups) can be mold (or other hydrophobic plastic molds) can be coated by packaging and autoclaving in a packaging saline that comprises two different types of coating materials. The first type of coating materials are lightly-crosslinked (or branched), thermally-crosslinkable hydrophilic polymeric material comprising thermally-crosslinkable groups (azetidinium groups and/or epoxide groups) that can react with carboxylic acid groups during autoclave. The other type of coating materials are diol-containing hydrophilic polymers comprising 1,2- or 1,3-diol moieties that can react with arylborono groups. By having two different types of coating materials, a hybrid coating with good intactness can be formed on a preformed SiHy contact lens having a relatively low amount of carboxylic acid. Consequently, resultant coated SiHy contact lenses can have a reduced susceptibility to carboxylic acid-induced degradation, thereby having an increased stability (longer shelf life).

The present invention provides a method for producing coated silicone hydrogel contact lenses, comprising the steps of: (1) obtaining a preformed silicone hydrogel contact lens, wherein the preformed hydrogel contact lens comprises a bulk silicone hydrogel material that comprises (a) repeating units of at least one polysiloxane vinylic crosslinker and/or at least one siloxane-containing vinylic monomer, (b) from about 0.5% to about 3.5% by weight of repeating units of at least one carboxyl-containing vinylic monomer relative to the total amount of all polymerizable components, (c) repeating units of at least one hydrophilic vinylic monomer, (d) from about 2.5% to about 12.5% by weight of repeating units of at least one arylborono-containing vinylic monomer having an arylborono group; (e) optionally but preferably at least one non-silicone vinylic crosslinker; and (2) heating the preformed silicone hydrogel contact lens in an aqueous coating solution at a temperature from about 60° C. to about 140° C. to form a coated silicone hydrogel contact lens comprising the bulk silicone hydrogel material and a non-silicone hydrogel coating thereon, wherein the aqueous coating solution comprises (a) at least one diol-containing hydrophilic polymer having 1,2- and/or 1,3-diol moieties and (b) at least one water-soluble, thermally-crosslinkable hydrophilic polymeric material that is branched or slightly-crosslinked and comprises thermally crosslinkable groups and optionally reactive functional groups, wherein the thermally crosslinkable group are azetidinium groups and/or epoxide groups, wherein the reactive functional groups are primary amino groups, secondary amino groups, carboxylic acid groups, thiol groups, or combinations thereof, wherein the non-silicone hydrogel coating comprises a crosslinked polymeric material and a grafted diol-containing hydrophilic polymer, wherein the crosslinked hydrophilic polymeric material is derived from said at least one water-soluble, thermally-crosslinkable hydrophilic polymeric material and is covalently attached to the bulk silicone hydrogel material through first linkages each formed between one carboxylic acid group and one azetidinium or epoxide group, wherein the grafted diol-containing hydrophilic polymer is derived from said at least one diol-containing hydrophilic polymer and is covalently attached to the bulk silicone hydrogel material through second linkages each formed between one arylboronoc group and one 1,2- or 1,3-diol moiety.

A preformed SiHy contact lens can be any SiHy contact lens which has not been subjected to any surface treatment after being produced according to any lens manufacturing processes, any contact lens which has been plasma treated or treated with any chemical or physical surface modification, or any commercial contact lens, so long as it does not have a hydrogel coating on the surface of the preformed SiHy contact lens. A person skilled in the art knows very well how to make preformed contact lenses. A person skilled in the art knows very well how to make preformed contact lenses. For example, preformed contact lenses can be produced in a conventional “spin-casting mold,” as described for example in U.S. Pat. No. 3,408,429, or by the full cast-molding process in a static form, as described in U.S. Pat. Nos. 4,347,198; 5,508,317; 5,583,463; 5,789,464; and 5,849,810, or by lathe cutting of polymeric material buttons as used in making customized contact lenses. In cast-molding, a polymerizable composition (i.e., a lens formulation) typically is dispensed into molds and cured (i.e., polymerized and/or crosslinked) in molds for making contact lenses.

Lens molds for making contact lenses including hydrogel contact lenses are well known to a person skilled in the art and, for example, are employed in cast molding or spin casting. For example, a mold (for cast molding) generally comprises at least two mold sections (or portions) or mold halves, i.e., first and second mold halves. The first mold half has a first molding (or optical) surface which is in direct contact with a polymerizable composition for cast molding of a contact lens and defines the posterior (concave) surface of a molded contact lens; and the second mold half has a second molding (or optical) surface which is in direct contact with the polymerizable composition and defines the anterior (convex) surface of the molded contact lens. The first and second mold halves are configured to receive each other such that a lens-forming cavity is formed between the first molding surface and the second molding surface.

Methods of manufacturing mold sections for cast molding a contact lens are generally well known to those of ordinary skill in the art. The process of the present invention is not limited to any particular method of forming a mold. In fact, any method of forming a mold can be used in the present invention.

The mold halves can be formed through various techniques, such as injection molding. Methods of manufacturing mold halves for cast-molding a contact lens are generally well known to those of ordinary skill in the art. The process of the present invention is not limited to any particular method of forming a mold. In fact, any method of forming a mold can be used in the present invention. The first and second mold halves can be formed through various techniques, such as injection molding or lathing. Examples of suitable processes for forming the mold halves are disclosed in U.S. Pat. Nos. 4,444,711; 4,460,534; 5,843,346; and 5,894,002.

Virtually all materials known in the art for making molds can be used to make molds for making contact lenses. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used. Other materials that allow UV light transmission could be used, such as quartz glass and sapphire.

In accordance with the present invention, a preformed SiHy contact lens can be produced from a polymerizable composition comprising (a) at least one polysiloxane vinylic crosslinker and/or at least one siloxane-containing vinylic monomer, (b) from about 0.5% to about 3.5% (preferably from about 0.7% to about 3.5%, more preferably from about 0.9% to about 3.0%, even more preferably from about 1.0% to about 2.8%) by weight of at least one carboxyl-containing vinylic monomer relative to the total amount of all polymerizable components, (c) at least one hydrophilic vinylic monomer, (d) from about 2.5% to about 12.5% (preferably from about 2.5% to about 10%, more preferably from about 3.0% to about 8.0%, even more preferably from about 3.5% to about 7.0%) by weight of at least one arylborono-containing vinylic monomer having an arylborono group; (e) optionally but preferably at least one non-silicone vinylic crosslinker; and (f) at least one free-radical initiator.

In accordance with the invention, a silicone-containing (or siloxane-containing) vinylic monomer can be any silicone-containing vinylic monomer known to a person skilled in the art. Examples of preferred silicone-containing vinylic monomers include without limitation vinylic monomers each having a bis(trialkylsilyloxy)alkylsilyl group (preferably a bis(trimethylsilyloxy)-alkylsilyl group) or a tris(trialkylsilyloxy)silyl group (preferably a tris(trimethylsilyloxy)silyl group), polysiloxane vinylic monomers, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof.

Examples of preferred siloxane-containing vinylic monomers each having a bis(trialkylsilyloxy)alkylsilyl group or a tris(trialkylsilyloxy)silyl group include without limitation tris(trimethylsilyloxy)-silylpropyl (meth)acrylate, [3-(meth)acryloxy-2-hydroxypropyloxy]propyl-bis(trimethylsiloxy)-methylsilane, [3-(meth)acryloxy-2-hydroxypropyloxy]propylbis(trimethyl-siloxy)butylsilane, 3-(meth)acryloxy-2-(2-hydroxyethoxy)-propyloxy)propylbis(trimethylsiloxy)-methylsilane, 3-(meth)acryloxy-2-hydroxypropyloxy)propyl-tris(trimethylsiloxy)silane, N-[tris(trimethylsiloxy)-silylpropyl]-(meth)acrylamide, N-(2-hydroxy-3-(3-(bis(trimethylsilyloxy)-methylsilyl)propyloxy)-propyl)-2-methyl (meth)acrylamide, N-(2-hydroxy-3-(3-(bis(trimethyl-silyloxy)methylsilyl)-propyloxy)propyl) (meth)acrylamide, N-(2-hydroxy-3-(3-(tris(trimethyl-silyloxy)silyl)propyloxy)-propyl)-2-methyl acrylamide, N-(2-hydroxy-3-(3-(tris(trimethylsilyloxy)-silyl)propyloxy)propyl) (meth)acrylamide, N-[tris(dimethylpropylsiloxy)-silylpropyl]-(meth)acrylamide, N-[tris(dimethylphenylsiloxy)silylpropyl] (meth)acrylamide, N-[tris(dimethyl-ethylsiloxy)silylpropyl] (meth)acrylamide, N,N-bis[2-hydroxy-3-(3-(bis(trimethyl-silyloxy)methyl-silyl)propyloxy)propyl]-2-methyl (meth)acrylamide, N,N-bis[2-hydroxy-3-(3-(bis(trimethylsilyloxy)-methylsilyl)propyloxy)-propyl] (meth)acrylamide, N,N-bis[2-hydroxy-3-(3-(tris(trimethylsilyloxy)-silyl)propyloxy)propyl]-2-methyl (meth)acrylamide, N,N-bis[2-hydroxy-3-(3-(tris(trimethylsilyloxy)-silyl)propyloxy)propyl] (meth)acrylamide, N-[2-hydroxy-3-(3-(t-butyldimethylsilyl)propyloxy)-propyl]-2-methyl (meth)acrylamide, N-[2-hydroxy-3-(3-(t-butyldimethylsilyl)propyloxy)propyl](meth)acrylamide, N,N-bis[2-hydroxy-3-(3-(t-butyldimethyl-silyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxy-carbonylthio)propyl-tris(trimethyl-siloxy)silane, 3-[tris(trimethylsiloxy)silyl]propylvinyl carbamate, 3-[tris(trimethylsiloxy)silyl] propyl allyl carbamate, 3-[tris(trimethylsiloxy)silyl]propyl vinyl carbonate, those disclosed in U.S. Pat. Nos. 9,097,840, 9,103,965 and 9,475,827, and mixtures thereof. The above preferred silicone-containing vinylic monomers can be obtained from commercial suppliers or can be prepared according to procedures described in U.S. Pat. Nos. 5,070,215, 6,166,236, 6,867,245, 7,214,809, 8,415,405, 8,475,529, 8,614,261, 8,658,748, 9,097,840, 9,103,965, 9,217,813, 9,315,669, and 9,475,827.

Examples of preferred polysiloxane vinylic monomers include without limitation mono-(meth)acryloyl-terminated, monoalkyl-terminated polysiloxanes of formula (I) include without limitation α-(meth)acryloxypropyl terminated ω-butyl (or ω-methyl) terminated polydimethylsiloxane, α-(meth)acryloxy-2-hydroxypropyloxypropyl terminated ω-butyl (or ω-methyl) terminated polydimethylsiloxane, α-(2-hydroxyl-methacryloxypropyloxypropyl)-ω-butyl-decamethylpentasiloxane, α-[3-(meth)acryloxyethoxy-2-hydroxypropyloxypropyl]-terminated ω-butyl (or ω-methyl) terminated polydimethylsiloxane, α-[3-(meth)acryloxy-propyloxy-2-hydroxypropyloxypropyl]-terminated ω-butyl (or ω-methyl) terminated polydimethylsiloxane, α-[3-(meth)acryloxyisopropyloxy-2-hydroxypropyloxypropyl]-terminated ω-butyl (or ω-methyl) terminated polydimethylsiloxane, α-[3-(meth)acryloxybutyloxy-2-hydroxypropyloxypropyl]-terminated ω-butyl (or ω-methyl) terminated polydimethylsiloxane, α-[3-(meth)acryloxy-ethylamino-2-hydroxypropyloxypropyl]-terminated ω-butyl (or ω-methyl) terminated polydimethylsiloxane, α-[3-(meth)acryloxypropylamino-2-hydroxypropyloxypropyl]-terminated ω-butyl (or ω-methyl) terminated polydimethylsiloxane, α-[3-(meth)acryloxy-butylamino-2-hydroxypropyloxypropyl]-terminated ω-butyl (or ω-methyl) terminated polydimethylsiloxane, α-(meth)acryloxy(polyethylenoxy)-2-hydroxypropyloxypropyl]-terminated ω-butyl (or ω-methyl) terminated polydimethylsiloxane, α-[(meth)acryloxy-2-hydroxypropyloxy-ethoxypropyl]-terminated ω-butyl (or ω-methyl) terminated polydimethylsiloxane, α-[(meth)acryloxy-2-hydroxypropyl-N-ethylaminopropyl]-terminated ω-butyl (or ω-methyl) terminated polydimethylsiloxane, α-[(meth)acryloxy-2-hydroxypropyl-aminopropyl]-terminated ω-butyl (or ω-methyl) terminated polydimethylsiloxane, α-[(meth)acryloxy-2-hydroxypropyloxy-(polyethylenoxy)propyl]-terminated ω-butyl (or ω-methyl) terminated polydimethylsiloxane, α-(meth)acryloylamidopropyloxypropyl terminated ω-butyl (or ω-methyl) terminated polydimethylsiloxane, α-N-methyl-(meth)acryloylamidopropyloxypropyl terminated ω-butyl (or ω-methyl) terminated polydimethylsiloxane, α-[3-(meth)acrylamidoethoxy-2-hydroxypropyloxy-propyl]-terminated ω-butyl (or ω-methyl) polydimethylsiloxane, α-[3-(meth)acrylamido-propyloxy-2-hydroxypropyloxypropyl]-terminated ω-butyl (or ω-methyl) terminated polydimethylsiloxane, α-[3-(meth)acrylamidoisopropyloxy-2-hydroxypropyloxypropyl]-terminated ω-butyl (or ω-methyl) terminated polydimethylsiloxane, α-[3-(meth)acrylamido-butyloxy-2-hydroxypropyloxypropyl]-terminated ω-butyl (or ω-methyl) terminated polydimethylsiloxane, α-[3-(meth)acryloylamido-2-hydroxypropyloxypropyl] terminated ω-butyl (or ω-methyl) polydimethylsiloxane, α-[3-[N-methyl-(meth)acryloylamido]-2-hydroxypropyloxy-propyl]terminated ω-butyl (or ω-methyl) terminated polydimethylsiloxane, N-methyl-N′-(propyltetra(dimethylsiloxy)dimethylbutylsilane) (meth)acrylamide, N-(2,3-dihydroxypropane)-N′-(propyltetra(dimethylsiloxy)dimethylbutylsilane) (meth)acrylamide, (meth)acryloylamido-propyltetra(dimethylsiloxy)dimethylbutylsilane, mono-vinyl carbonate-terminated mono-alkyl-terminated polydimethylsiloxanes, mono-vinyl carbamate-terminated mono-alkyl-terminated polydimethylsiloxane, those disclosed in U.S. Pat. Nos. 9,097,840 and 9,103,965, and mixtures thereof. The above preferred polysiloxanes vinylic monomers can be obtained from commercial suppliers (e.g., Shin-Etsu, Gelest, etc.) or prepared according to procedures described in patents, e.g., U.S. Pat. Appl. Pub. Nos. 6166236, 6867245, 8415405, 8475529, 8614261, 9217813, and 9315669, or by reacting a hydroxyalkyl (meth)acrylate or (meth)acrylamide or a (meth)acryloxypolyethylene glycol with a mono-epoxypropyloxypropyl-terminated polydimethylsiloxane, by reacting glycidyl (meth)acrylate with a mono-carbinol-terminated polydimethylsiloxane, a mono-aminopropyl-terminated polydimethylsiloxane, or a mono-ethylaminopropyl-terminated polydimethylsiloxane, or by reacting isocyanatoethyl (meth)acrylate with a mono-carbinol-terminated polydimethylsiloxane according to coupling reactions well known to a person skilled in the art.

In accordance with the invention, any polysiloxane vinylic crosslinkers can be used in this invention. Examples of preferred polysiloxane vinylic crosslinkers include without limitation α,ω-(meth)acryloxy-terminated polydimethylsiloxanes of various molecular weight; α,ω-(meth)acrylamido-terminated polydimethylsiloxanes of various molecular weight; α,ω-vinyl carbonate-terminated polydimethylsiloxanes of various molecular weight; α,ω-vinyl carbamate-terminated polydimethylsiloxane of various molecular weight; bis-3-methacryloxy-2-hydroxypropyloxypropyl polydimethylsiloxane of various molecular weight; N,N,N′,N′-tetrakis(3-methacryloxy-2-hydroxypropyl)-alpha,omega-bis-3-aminopropyl-polydimethylsiloxane of various molecular weight; the reaction products of glycidyl methacrylate with di-amino-terminated polydimethylsiloxanes; the reaction products of glycidyl methacrylate with di-hydroxyl-terminated polydimethylsiloxanes; the reaction products of an azlactone-containing vinylic monomer (any one of those described above) with di-hydroxyl-terminated polydimethylsiloxanes; the reaction products of isocyantoethyl (meth)acrylate with di-hydroxyl-terminated polydimethylsiloxanes; the reaction products of isocyantoethyl(meth)acrylate with diamino-terminated polydimethylsiloxanes; polysiloxane vinylic crosslinkers disclosed in U.S. Pat. Nos. 5,760,100; 4,136,250, 4,153,641, 4,182,822, 4,189,546, 4,259,467, 4,260,725, 4,261,875, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,449,729, 5,451,617, 5,486,579, 5,962,548, 5,981,675, 6,039,913, 6,762,264, 7,423,074, 8,163,206, 8,480,227, 8,529,057, 8,835,525, 8,993,651, 9,187,601, 10,081,697, 10,301,451, and 10,465,047.

One class of preferred polysiloxane vinylic crosslinkers are vinylic crosslinkers which are prepared by: reacting glycidyl (meth)acrylate or (meth)acryloyl chloride with a di-amino-terminated polydimethylsiloxane or a di-hydroxyl-terminated polydimethylsiloxane; reacting isocyantoethyl (meth)acrylate with di-hydroxyl-terminated polydimethylsiloxanes; reacting an amino-containing acrylic monomer with di-carboxyl-terminated polydimethylsiloxane in the presence of a coupling agent (a carbodiimide); reacting a carboxyl-containing acrylic monomer with di-amino-terminated polydimethylsiloxane in the presence of a coupling agent (a carbodiimide); or reacting a hydroxyl-containing acrylic monomer with a di-hydroxy-terminated polydisiloxane in the presence of a diisocyanate or di-epoxy coupling agent.

Examples of such preferred polysiloxane vinylic crosslinkers are α,ω-bis[3-(meth)acrylamidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, α,ω-bis[3-(meth)acryloxy-isopropyloxy-2-hydroxypropyloxy-propyl]-terminated polydimethylsiloxane, α,ω-bis[3-(meth)acryloxybutyloxy-2-hydroxypropyloxy-propyl]-terminated polydimethylsiloxane, α,ω-bis[3-(meth)acrylamidoethoxy-2-hydroxypropyloxy-propyl]-terminated polydimethylsiloxane, α,ω-bis[3-(meth)acrylamidopropyloxy-2-hydroxypropyloxypropyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxyethyl-amino-2-hydroxypropyloxypropyl]-terminated polydimethylsiloxane, α,ω-bis[3-(meth)acryloxy-propylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxypropyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, and combinations thereof.

Another class of preferred polysiloxane vinylic crosslinkers are chain-extended polysiloxane vinylic crosslinkers each of which comprises at least two polysiloxane segments and can be prepared according to the procedures described in U.S. Pat. Nos. 5,034,461, 5,416,132, 5,449,729, 5,760,100, 7,423,074, 8,529,057, 8,835,525, 8,993,651, and 10301451 and in U.S. Pat. App. Pub. No. 2018-0100038 A1.

A further class of preferred polysiloxane vinylic crosslinkers are hydrophilized polysiloxane vinylic crosslinkers that each comprise at least about 1.50 (preferably at least about 2.0, more preferably at least about 2.5, even more preferably at least about 3.0) milliequivalent/gram (“meq/g”) of hydrophilic moieties, which preferably are hydroxyl groups (—OH), carboxyl groups (—COOH), amino groups (—NHR_{N1} in which R_{N1} is H or C₁-C₂ alkyl), amide moieties (—CO—NR_{N1}R_{N2} in which R_{N1} is H or C₁-C₂ alkyl and R_{N2} is a covalent bond, H, or C₁-C₂ alkyl), N—C₁-C₃ acylamino groups, urethane moieties (—NH—CO—O—), urea moieties (—NH—CO—NH—), a polyethylene glycol chain of

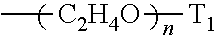

in which n is an integer of 2 to 20 and T, is H, methyl or acetyl or a phosphorylcholin group, or combinations thereof.

Examples of such preferred hydrophilized polysiloxane vinylic crosslinkers are those compounds of formula (1)

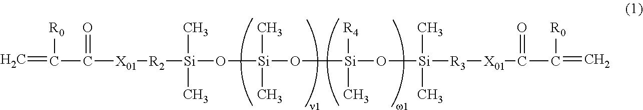

in which:
   ν1 is an integer of from 30 to 500 and ω1 is an integer of from 1 to 75, provided that ω1/ν1 is from about 0.035 to about 0.15 (preferably from about 0.040 to about 0.12, even more preferably from about 0.045 to about 0.10);
   X₀₁ is O or NRₙ in which Rₙ is hydrogen or C₁-C₁₀-alkyl;
   Rₒ is hydrogen or methyl;
   R₂ and R₃ independently of each other are a substituted or unsubstituted C₁-C₁₀ alkylene divalent radical or a divalent radical of —R₅—O—R₆— in which R₅ and R₆ independently of each other are a substituted or unsubstituted C₁-C₁₀ alkylene divalent radical;
   R₄ is a monovalent radical of any one of formula (2) to (7)

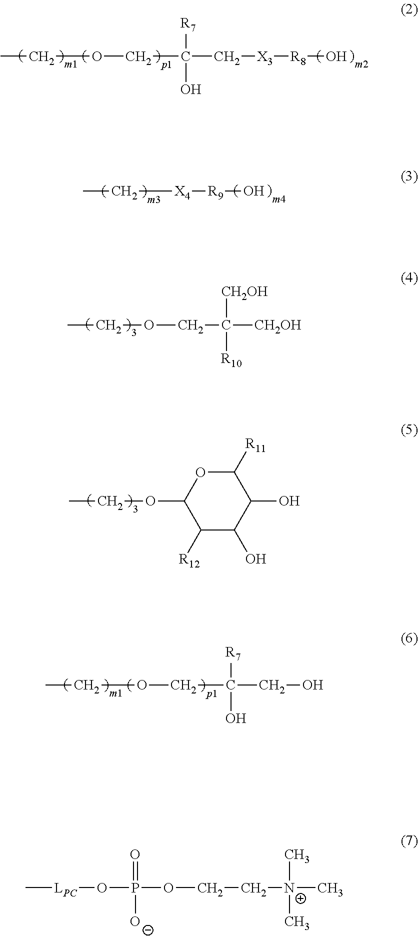

p1 is zero or 1; m1 is an integer of 2 to 4; m2 is an integer of 1 to 5; m3 is an integer of 3 to 6; m4 is an integer of 2 to 5;
R₇ is hydrogen or methyl;
R₈ is a C₂-C₆ hydrocarbon radical having (m2+1) valencies;
R₉ is a C₂-C₆ hydrocarbon radical having (m4+1) valencies;
R₁₀ is ethyl or hydroxymethyl;
R₁₁ is methyl or hydromethyl;
R₁₂ is hydroxyl or methoxy;
X₃ is a sulfur linkage of —S— or a tertiary amino linkage of —NR₁₃— in which R₁₃ is C₁-C₁ alkyl, hydroxyethyl, hydroxypropyl, or 2,3-dihydroxypropyl;
X₄ is an amide linkage of

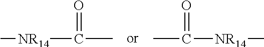

in which R₁₄ is hydrogen or C₁-C₁₀ alkyl;
L_{PC} is a divalent radical of —CH₂—CHR₀—R₁₅—, —C₃H₆—O—R₁₆—, C₃H₆ [symbol] O—C₂H₄ [symbol] _{q1}, —C₃H₆ [symbol] O—C₃H₆ [symbol] _{q1},

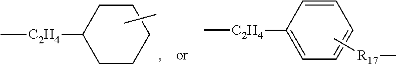

in which q1 is an integer of 1 to 20, R₁₅ is a linear or branched C₁-C₁₀ alkylene divalent radical, R₁₆ is a linear or branched C₃-C₁₀ alkylene divalent radical, and R₁₇ is a direct bond or a linear or branched C₁-C₄ alkylene divalent radical.

The procedures for preparing a polysiloxane vinylic crosslinkers of formula (1) have been described in detail in U.S. Pat. No. 10,081,697 and U.S. Pat. Appl. Pub. No. 2022/0251302 A1.

In accordance with the invention, any carboxyl-containing vinylic monomer can be used in the invention. Examples of preferred carboxyl-containing (meth)acryloxy monomers include without limitation acrylic acid, C₁-C₄ alkylacrylic acid (e.g., methacrylic acid, ethylacrylic acid, propylacrylic acid, butylacrylic acid), (meth)acrylox-C₁-C₆ alkanoic acid (e.g., (meth)acryloyloxy-acetic acid, (meth)acryloyloxypropanoic acid, (meth)acryloyloxybutanoic acid, (meth)acryloyloxypentanoic acid, (meth)acryloyloxyhexanoic acid), mono-2-[(meth)acryloxy]-ethyl succinate, (meth)acrylamido-C₁-C₆ alanoic acid (3-(meth)acrylamidopropionic acid, 4-(meth)acrylamidobutanoic acid, 5-(meth)acrylamidopentanoic acid, 6-(meth)acrylamidohexanoic acid), 2-acrylamidoglycolic acid, and combinations thereof

Any hydrophilic vinylic monomers can be used in the invention. Examples of preferred hydrophilic vinylic monomers are alkyl (meth)acrylamides (as described later in this application), hydroxyl-containing acrylic monomers (as described below), amino-containing acrylic monomers (as described later in this application), N-vinyl amide monomers (as described later in this application), methylene-containing pyrrolidone monomers (i.e., pyrrolidone derivatives each having a methylene group connected to the pyrrolidone ring at 3- or 5-position) (as described later in this application), acrylic monomers having a C₁-C₄ alkoxyethoxy group (as described later in this application), vinyl ether monomers (as described later in this application), allyl ether monomers (as described later in this application), phosphorylcholine-containing vinylic monomers (as described later in this application), N-2-hydroxyethyl vinyl carbamate, N-carboxyvinyl-β-alanine (VINAL), N-carboxyvinyl-α-alanine, and combinations thereof.

Examples of alkyl (meth)acrylamides include without limitation (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, and combinations thereof.

Examples of hydroxyl-containing acrylic monomers include without limitation N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, and combinations thereof.

Examples of preferred N-vinyl amide monomers include without limitation N-vinylpyrrolidone (aka, N-vinyl-2-pyrrolidone), N-vinyl-3-methyl-2-pyrrolidone, N-vinyl-4-methyl-2-pyrrolidone, N-vinyl-5-methyl-2-pyrrolidone, N-vinyl-6-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-vinyl piperidone (aka, N-vinyl-2-piperidone), N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl caprolactam (aka, N-vinyl-2-caprolactam), N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinyl-N-methyl acetamide, N-vinyl formamide, N-vinyl acetamide, N-vinyl isopropylamide, N-vinyl-N-ethyl acetamide, N-vinyl-N-ethyl formamide, and mixtures thereof. Preferably, the N-vinyl amide monomer is N-vinylpyrrolidone, N-vinyl-N-methyl acetamide, or combinations thereof.

Examples of preferred methylene-containing (═CH₂) pyrrolidone monomers include without limitations 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and combinations thereof.

Examples of preferred acrylic monomers having a C₁-C₄ alkoxyethoxy group include without limitation ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol)ethyl (meth)acrylate having a weight average molecular weight of up to 1500, methoxy-poly(ethylene glycol)ethyl (meth)acrylamide having a number average molecular weight of up to 1500, and combinations thereof.

Examples of preferred vinyl ether monomers include without limitation ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, and combinations thereof.

Examples of preferred allyl ether monomers include without limitation allyl alcohol, ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, and combinations thereof.

Examples of preferred phosphorylcholine-containing vinylic monomers include without limitation (meth)acryloyloxyethyl phosphorylcholine (aka, MPC, or 2-((meth)acryloyloxy)ethyl-2′-(trimethylammonio)ethylphosphate), (meth)acryloyloxypropyl phosphorylcholine (aka, 3-((meth)acryloyloxy)propyl-2′-(trimethylammonio)ethylphosphate), 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]propyl-2′-(trimethylammonio)ethylphosphate, 4-[(meth)acryloylamino]butyl-2′-(trimethylammonio)ethylphosphate, 5-((meth)acryloyloxy)pentyl-2′ (trimethylammonio)ethyl phosphate, 6-((meth)acryloyloxy)hexyl-2′-(trimethylammonio)-ethylphosphate, 2-((meth)acryloyloxy)ethyl-2′-(triethylammonio)ethylphosphate, 2-((meth)acryloyloxy)ethyl-2′-(tripropylammonium)ethylphosphate, 2-((meth)acryloyloxy)ethyl-2′-(tributylammonio)ethyl phosphate, 2-((meth)acryloyloxy)propyl-2′-(trimethyl ammonio)-ethylphosphate, 2-((meth)acryloyloxy)butyl-2′-(trimethylammonio)ethylphosphate, 2-((meth)acryloyloxy)pentyl-2′-(tri methylammonio)ethylphosphate, 2-((meth)acryloyloxy)hexyl-2′-(trimethylammonio)ethyl phosphate, 2-(vinyloxy)ethyl-2′-(triethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2-(trimethylammonio)-ethylphosphate, 2-(vinylcarbonylamino)ethyl-2′-(trimethylammonio)ethylphosphate, 2-(allyloxycarbonylamino)ethyl-2′-(trimethylammonio)ethyl phosphate, 2-(butenoyloxy)ethyl-2′-(trimethylammonio)ethylphosphate, and combinations thereof.

In a preferred embodiment, an arylborono-containing vinylic monomer is represented by formula (I)

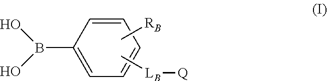

in which: R_{B} is a monovalent radical (preferably is H, NO₂, F, Cl, Br, CF₃, CH₂OH, or CH₂NR^{o}R^{o′}
   in which R^{o} and R^{o′} independent of each other are H or C₁-C₄ alkyl); Q is a monovalent radical of

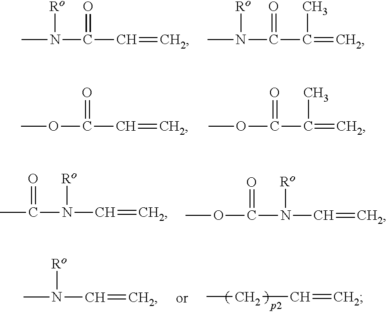

L_{B} is a direct bond, a C₁-C₄ alkylene divalent radical, a divalent radical of

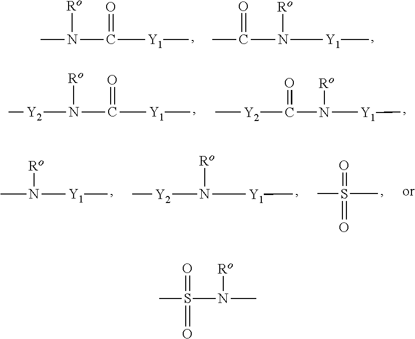

in which Y₁ is CH(OH) or a C₁-C₄ alkylene divalent radical, Y₂ is a C₁-C₄ alkylene divalent radical, p2 is an integer of 0 to 3, and R^{o} is H or a C₁-C₄ alkyl.

Examples of preferred arylborono-containing vinylic monomers of formula (I) include without limitation 3-vinylphenylboronic acid, 4-vinylphenylboronic acid (pKa ˜8.8), 3-(meth)acrylamidophenylboronic acid (pKa ˜8.2), 4-(meth)acrylamidophenylboronic acid, 4-(1,6-dioxo-2,5-diaza-7-oxamyl)phenylboronic acid (pKa ˜7.8), 2-dimethylaminomethyl-5-vinylphenyl-boronic acid (pKa <7.8), 4-(N-allylsulfamoyl)phenylboronic acid (pKa ˜7.4), 4-(3-butenylsulfonyl)phenylboronic acid (pKa ˜7.1), 3-(meth)acrylamido-5-nitrophenylboronic acid, 4-(meth)acrylamido-5-nitrophenylboronic acid, 4-(meth)acrylamido-3-nitrophenylboronic acid, 3-[(meth)acrylamido-C₂-C₅-alkylaminocarbonyl]-5-nitrophenylboronic acid, 3-[(meth)acryloyloxy-C₂-C₅-alkylaminocarbonyl]-5-nitrophenylboronic acid, 3-(meth)acrylamido-6-hydroxymethyl-phenylboronic acid, 3-(meth)acrylamido-6-dimethylaminomethylphenylboronic acid, 4-(meth)acrylamido-6-hydroxymethylphenylboronic acid, 4-(meth)acrylamido-6-dimethylamino-methylphenylboronic acid, a reaction production of an amino-containing phenylboronic acid derivative with (meth)acrylic acid halide or an epoxide-containing vinylic monomer or with a carboxy-containing vinylic monomer in the presence of a carbodiimide (e.g., 1-ethyl-3-(3-dimethylaminopropyl) carbodiimide (EDC), N,N′-dicyclohexyl-carbodiimide (DCC), 1-cylcohexyl-3-(2-morpholinoethyl)carbodiimide, diisopropyl carbodiimide, or mixtures thereof) and N-hydroxysuccinimide, a reaction production of a carboxy-containing phenylboronic acid derivative with an amino-containing vinylic monomer in the presence of a carbodiimide (e.g., 1-ethyl-3-(3-dimethylaminopropyl) carbodiimide (EDC), N,N′-dicyclohexyl-carbodiimide (DCC), 1-cylcohexyl-3-(2-morpholinoethyl)carbodiimide, diisopropyl carbodiimide, or mixtures thereof) and N-hydroxysuccinimide, and combinations thereof.

Examples of preferred carboxyl-containing phenylboronic acid derivatives include without limitation 3-carboxyphenylboronic acid, 4-carboxyphenylboronic acid, 3-boronophenyl-acetic acid, 4-boronophenylacetic acid, 2-(4-boronophenyl)-2-methylpropanoic acid, 3-(4-boronophenyl)propanoic acid, 3-(3-boronophenyl)propanoic acid, 5-(3-boronophenyl)pentanoic acid, 5-(4-boronophenyl)pentanoic acid, 4-(2-carboxyethyl)-3-nitrophenylboronic acid, 3-carboxy-5-nitrophenylboronic acid, 4-carboxy-30chlorophenylboronic acid, 3-carboxy-4-fluorophenylbornic acid, 3-(3-carboxypropyonylamino)phenylboronic acid, 3-amino-3-(4-boronophenyl)propanoic acid, and combinations thereof.

Examples of preferred amino-containing phenylboronic acid derivatives include without limitation 3-aminophenylboronic acid, 4-aminophenylboronic acid, 4-amino-3-nitrophenylboronic acid, 3-amino-6-hydroxymethylphenylboronic acid, 3-amino-6-(dimethylaminomethyl)phenyl-boronic acid, 4-amino-2-hydroxymethylphenylboronic acid, 4-amino-2-(dimethylaminomethyl)-phenylboronic acid, 3-amino-4-fluorophenylboronic acid, 4-(aminomethyl)-5-nitrophenylboronic acid, 3-(aminomethyl)-phenylboronic acid, 3-amino-5-nitrophenylboronic acid, 3-amino-3-(4-boronophenyl)propanoic acid, and combinations thereof.

Examples of preferred acetal-containing phenylboronic acid derivatives include without limitation 2-acetoxyphenylboronic acid, 3-acetoxyphenylboronic acid, 4-acetoxyphenylboronic acid, 2-formylphenylboronic acid, 3-formylphenylboronic acid, 4-formylphenylboronic acid, 5-formyl-2-methoxyphenylboronic acid, 3-fluoro-4-formylphenylboronic acid, 4-fluoro-3-formylphenylboronic acid, and combinations thereof.

Examples of preferred carboxy-containing vinylic monomer include without limitation those described above.

Examples of preferred amino-containing vinylic monomers include without limitation amino-C₂-C₄ alkyl (meth)acrylate (e.g., 2-aminoethyl (meth)acrylate, 3-aminopropyl (meth)acrylate, 3-amino-2-hydroxypropyl (meth)acrylate), C₁-C₃ alkylamino-C₂-C₄ alkyl (meth)acrylate (e.g., 2-methylaminoethyl (meth)acrylate, 2-ethylaminoethyl (meth)acrylate, 3-methylaminopropyl (meth)acrylate, 3-ethylaminopropyl (meth)acrylate), amino-C₂-C₄ alkyl (meth)acrylamide (e.g., N-2-aminoethyl (meth)acrylamide, N-3-aminopropyl (meth)acrylamide, N-4-aminobutyl (meth)acrylamide), C₁-C₃ alkylamino-C₂-C₄ alkyl (meth)acrylamide (e.g., N-2-methylaminoethyl (meth)acrylamide, N-2-ethylaminoethyl (meth)acrylamide, N-3-methylaminopropyl (meth)acrylamide), vinylamine, allylamine, and combinations thereof.

Examples of preferred epoxide-containing vinylic monomers include without limitation glycidyl (meth)acrylamide, hydroxylethyl (meth)acrylamide glycidyl ether, 3-hydroxypropyl (meth)acrylamide glycidyl ether, 4-hydroxybutyl (meth)acrylamide glycidyl ether, glycidyl (meth)acrylate, hydroxylethyl (meth)acrylate glycidyl ether, 3-hydroxypropyl (meth)acrylate glycidyl ether, 4-hydroxybutyl (meth)acrylate glycidyl ether, and combinations thereof.

In accordance with the invention, any non-silicone vinylic crosslinkers can be in this invention. Examples of preferred non-silicone vinylic cross-linking agents include without limitation ethyleneglycol di-(meth)acrylate, diethyleneglycol di-(meth)acrylate, triethyleneglycol di-(meth)acrylate, tetraethyleneglycol di-(meth)acrylate, polyethylene glycol di-(meth)acrylate having a number averaged molecular weight of from 200 to 10,000 daltons, glycerol di-(meth)acrylate, 1,3-propanediol di-(meth)acrylate, 1,3-butanediol di-(meth)acrylate, 1,4-butanediol di-(meth)acrylate, glycerol 1,3-diglycerolate di-(meth)acrylate, ethylenebis[oxy(2-hydroxypropane-1,3-diyl)] di-(meth)acrylate, bis[2-(meth)acryloxyethyl] phosphate, trimethylolpropane di-(meth)acrylate, and 3,4-bis[(meth)acryloyl]tetrahydrofuan, diacrylamide (i.e., N-(1-oxo-2-propenyl)-2-propenamide), dimethacrylamide (i.e., N-(1-oxo-2-methyl-2-propenyl)-2-methyl-2-propenamide), N,N-di(meth)acryloyl-N-methylamine, N,N-di(meth)acryloyl-N-ethylamine, N,N′-methylene bis(meth)acrylamide, N,N′-ethylene bis(meth)acrylamide, N,N′-dihydroxyethylene bis(meth)acrylamide, N,N′-propylene bis(meth)acrylamide, N,N′-2-hydroxypropylene bis(meth)acrylamide, N,N′-2,3-dihydroxybutylene bis(meth)acrylamide, 1,3-bis(meth)acrylamide-propane-2-yl dihydrogen phosphate (i.e., N,N′-2-phophonyloxypropylene bis(meth)acrylamide), piperazine diacrylamide (or 1,4-bis(meth)acryloyl piperazine), triallyl isocyanurate, triallyl cyanurate, and combinations thereof, more preferably selected from the group consisting of ethyleneglycol di-(meth)acrylate, diethyleneglycol di-(meth)acrylate, triethyleneglycol di-(meth)acrylate, tetraethyleneglycol di-(meth)acrylate, polyethylene glycol di-(meth)acrylate having a number averaged molecular weight of from 200 to 10,000 daltons, and combinations thereof.

In accordance with the invention, a free radical initiator can be either a photoinitiator or a thermal initiator. A “photoinitiator” refers to a chemical that initiates free radical crosslinking/polymerizing reaction by the use of light. A “thermal initiator” refers to a chemical that initiates free radical crosslinking/polymerizing reaction by the use of heat energy.

Any thermal polymerization initiators can be used in the invention. Suitable thermal polymerization initiators are known to the skilled artisan and comprise, for example peroxides, hydroperoxides, azo-bis(alkyl- or cycloalkylnitriles), persulfates, percarbonates, or mixtures thereof. Examples of preferred thermal polymerization initiators include without limitation benzoyl peroxide, t-butyl peroxide, t-amyl peroxybenzoate, 2,2-bis(tert-butylperoxy)butane, 1,1-bis(tert-butylperoxy)cyclohexane, 2,5-Bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxyphthalate, t-butyl hydro-peroxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof. Preferably, the thermal initiator is 2,2′-azobis(isobutyronitrile) (AIBN or VAZO 64).

Suitable photoinitiators are benzoin methyl ether, diethoxyacetophenone, a benzoylphosphine oxide, 1-hydroxycyclohexyl phenyl ketone and Darocur and Irgacur types, preferably Darocur 1173® and Darocur 2959®, Germanium-based Norrish Type I photoinitiators (e.g., those described in U.S. Pat. No. 7,605,190). Examples of benzoylphosphine initiators include 2,4,6-trimethylbenzoyldiphenylophosphine oxide; bis-(2,6-dichlorobenzoyl)-4-N-propylphenylphosphine oxide; and bis-(2,6-dichlorobenzoyl)-4-N-butylphenylphosphine oxide. Reactive photoinitiators which can be incorporated, for example, into a macromer or can be used as a special monomer are also suitable. Examples of reactive photoinitiators are those disclosed in EP 632 329.

A SiHy lens formulation (i.e., a polymerizable composition) can also comprise other necessary components known to a person skilled in the art, such as, for example, one or more non-silicone hydrophobic vinylic monomers, a UV-absorbing vinylic monomer, a polymerizable UV/high-energy-violet-light (“HEVL”) absorbing compound (including UV/HEVL absorbing vinylic monomer described below, and/or polymerizable Cu(II)-porphyrins described in U.S. Pat. Appl. Pub. No. 20150316688), a polymerizable photochromic compound, a visibility tinting agent (e.g., reactive dyes, polymerizable dyes, pigments, or mixtures thereof, as well known to a person skilled in the art), antimicrobial agents (e.g., preferably silver nanoparticles), a bioactive agent, leachable lubricants (e.g., non-polymerizable hydrophilic polymers, etc.), leachable tear-stabilizing agents (e.g., phospholipids, monoglycerides, diglycerides, triglycerides, glycolipids, glyceroglycolipids, sphingolipids, sphingo-glycolipids, etc.), and mixtures thereof, as known to a person skilled in the art.

In accordance with the invention, any non-silicone hydrophobic hydrophobic vinylic monomers can be in this invention. Examples of preferred non-silicone hydrophobic vinylic monomers include methyl (meth)acrylate, ethyl (meth)acrylate, propyl (meth)acrylate, isopropyl (meth)acrylate, cyclohexyl (meth)acrylate, 2-ethylhexyl (meth)acrylate, vinyl acetate, vinyl propionate, vinyl butyrate, vinyl valerate, styrene, chloroprene, vinyl chloride, vinylidene chloride, (meth)acrylonitrile, 1-butene, butadiene, vinyl toluene, vinyl ethyl ether, perfIuorohexylethyl-thio-carbonyl-aminoethyl-methacrylate, isobornyl (meth)acrylate, trifluoroethyl (meth)acrylate, hexafluoro-isopropyl (meth)acrylate, hexafluorobutyl (meth)acrylate, and combinations thereof.

Any suitable UV-absorbing vinylic monomers and UV/HEVL-absorbing vinylic monomers can be used in a polymerizable composition for preparing a preformed SiHy contact lens of the invention. Examples of preferred UV-absorbing and UV/HEVL-absorbing vinylic monomers include without limitation: 2-(2-hydroxy-5-vinylphenyl)-2H-benzotriazole, 2-(2-hydroxy-5-acrylyloxyphenyl)-2H-benzotriazole, 2-(2-hydroxy-3-methacrylamido methyl-5-tert octylphenyl) benzotriazole, 2-(2′-hydroxy-5′-methacrylamidophenyl)-5-chlorobenzotriazole, 2-(2′-hydroxy-5′-methacrylamidophenyl)-5-methoxybenzotriazole, 2-(2′-hydroxy-5′-methacryloxypropyl-3′-t-butyl-phenyl)-5-chlorobenzotriazole, 2-(2′-hydroxy-5′-methacryloxypropylphenyl) benzotriazole, 2-hydroxy-5-methoxy-3-(5-(trifluoromethyl)-2H-benzo[d][1,2,3]triazol-2-yl)benzyl methacrylate (WL-1), 2-hydroxy-5-methoxy-3-(5-methoxy-2H-benzo[d][1,2,3]triazol-2-yl)benzyl methacrylate (WL-5), 3-(5-fluoro-2H-benzo[d][1,2,3]triazol-2-yl)-2-hydroxy-5-methoxybenzyl methacrylate (WL-2), 3-(2H-benzo[d][1,2,3]triazol-2-yl)-2-hydroxy-5-methoxybenzyl methacrylate (WL-3), 3-(5-chloro-2H-benzo[d][1,2,3]triazol-2-yl)-2-hydroxy-5-methoxybenzyl methacrylate (WL-4), 2-hydroxy-5-methoxy-3-(5-methyl-2H-benzo[d][1,2,3]triazol-2-yl)benzyl methacrylate (WL-6), 2-hydroxy-5-methyl-3-(5-(trifluoromethyl)-2H-benzo[d][1,2,3]triazol-2-yl)benzyl methacrylate (WL-7), 4-allyl-2-(5-chloro-2H-benzo[d][1,2,3]triazol-2-yl)-6-methoxyphenol (WL-8), 2-{2′-Hydroxy-3′-tert-5′[3″-(4″-vinylbenzyloxy)propoxy]phenyl}-5-methoxy-2H-benzotriazole, phenol, 2-(5-chloro-2H-benzotriazol-2-yl)-6-(1,1-dimethylethyl)-4-ethenyl-(UVAM), 2-[2′-hydroxy-5′-(2-methacryloxyethyl)phenyl)]-2H-benzotriazole (2-Propenoic acid, 2-methyl-, 2-[3-(2H-benzotriazol-2-yl)-4-hydroxyphenyl]ethyl ester, Norbloc), 2-{2′-Hydroxy-3′-tert-butyl-5′-[3′-methacryloyloxypropoxy]phenyl}-2H-benzotriazole, 2-{2′-Hydroxy-3′-tert-butyl-5′-[3′-methacryloyloxypropoxy]phenyl}-5-methoxy-2H-benzotriazole (UV13), 2-{2′-Hydroxy-3′-tert-butyl-5′-[3′-methacryloyloxypropoxy]phenyl}-5-chloro-2H-benzotriazole (UV28), 2-[2′-Hydroxy-3′-tert-butyl-5′-(3′-acryloyloxypropoxy)phenyl]-5-trifluoromethyl-2H-benzotriazole (UV23), 2-(2′-hydroxy-5-methacrylamidophenyl)-5-methoxybenzotriazole (UV6), 2-(3-allyl-2-hydroxy-5-methylphenyl)-2H-benzotriazole (UV9), 2-(2-Hydroxy-3-methallyl-5-methylphenyl)-2H-benzotriazole (UV12), 2-3′-t-butyl-2′-hydroxy-5′-(3″-dimethylvinylsilylpropoxy)-2′-hydroxy-phenyl)-5-methoxybenzotriazole (UV15), 2-(2′-hydroxy-5′-methacryloylpropyl-3′-tert-butyl-phenyl)-5-methoxy-2H-benzotriazole (UV16), 2-(2′-hydroxy-5′-acryloylpropyl-3′-tert-butyl-phenyl)-5-methoxy-2H-benzotriazole (UV16A), 2-Methylacrylic acid 3-[3-tert-butyl-5-(5-chlorobenzotriazol-2-yl)-4-hydroxyphenyl]-propyl ester (16-100, CAS #96478-15-8), 2-(3-(tert-butyl)-4-hydroxy-5-(5-methoxy-2H-benzo[d][1,2,3]triazol-2-yl)phenoxy)ethyl methacrylate (16-102); Phenol, 2-(5-chloro-2H-benzotriazol-2-yl)-6-methoxy-4-(2-propen-1-yl) (CAS #1260141-20-5); 2-[2-Hydroxy-5-[3-(methacryloyloxy)propyl]-3-tert-butylphenyl]-5-chloro-2H-benzotriazole; Phenol, 2-(5-ethenyl-2H-benzotriazol-2-yl)-4-methyl-, homopolymer (9C1) (CAS #83063-87-0). In accordance with the invention, the polymerizable composition comprises about 0.1% to about 3.0%, preferably about 0.2% to about 2.5%, more preferably about 0.3% to about 2.0%, by weight of one or more UV-absorbing vinylic monomers, related to the amount of all polymerizable components in the polymerizable composition.

Examples of preferred photochromic vinylic monomers include polymerizable naphthopyrans, polymerizable benzopyrans, polymerizable indenonaphthopyrans, polymerizable phenanthropyrans, polymerizable spiro(benzindoline)-naphthopyrans, polymerizable spiro(indoline)benzopyrans, polymerizable spiro(indoline)-naphthopyrans, polymerizable spiro(indoline)quinopyrans, polymerizable spiro(indoline)-pyrans, polymerizable naphthoxazines, polymerizable spirobenzopyrans; polymerizable spirobenzopyrans, polymerizable spirobenzothiopyrans, polymerizable naphthacenediones, polymerizable spirooxazines, polymerizable spiro(indoline)naphthoxazines, polymerizable spiro(indoline)-pyridobenzoxazines, polymerizable spiro(benzindoline)pyridobenzoxazines, polymerizable spiro(benzindoline)naphthoxazines, polymerizable spiro(indoline)-benzoxazines, polymerizable diarylethenes, and combinations thereof, as disclosed in U.S. Pat. Nos. 4,929,693, 5,166,345 6,017,121, 7,556,750, 7,584,630, 7,999,989, 8,158,037, 8,697,770, 8,741,188, 9,052,438, 9,097,916, 9,465,234, 9,904,074, 10,197,707, 6,019,914, 6,113,814, 6,149,841, 6,296,785, and 6,348,604.

A polymerizable composition (SiHy lens formulation) can be a solventless clear liquid prepared by mixing all polymerizable components and other necessary component or a solution prepared by dissolving all of the desirable components in any suitable solvent, such as, a mixture of water and one or more organic solvents miscible with water, an organic solvent, or a mixture of one or more organic solvents, as known to a person skilled in the art. The term “solvent” refers to a chemical that cannot participate in free-radical polymerization reaction.

A solventless lens SiHy lens formulation typically comprises at least one blending vinylic monomer as a reactive solvent for dissolving all other polymerizable components of the solventless SiHy lens formulation. Examples of preferred blending vinylic monomers are described later in this application. Preferably, methyl methacrylate is used as a blending vinylic monomer in preparing a solventless SiHy lens formulation.

Any solvents can be used in the invention. Example of preferred organic solvents includes without limitation, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimetyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-pyrrolidone, N,N-dimethylpropionamide, dimethyl formamide, dimethyl acetamide, dimethyl propionamide, N-methyl pyrrolidinone, and mixtures thereof.

In a preferred embodiment, the polymerizable composition comprises: (i) at least one hydrophilized polysiloxane vinylic crosslinker, (ii) optionally but preferably hydroxyethyl methacrylate, (iii) at least one C₁-C₂ alkoxyethyl (meth)acrylate, (iv) from about 0.5% to about 3.5% (preferably from about 0.7% to about 3.5%, more preferably from about 0.9% to about 3.0%, even more preferably from about 1.0% to about 2.8%) by weight of at least one carboxyl-containing vinylic monomer relative to the total amount of all polymerizable components, (v) from about 2.5% to about 12.5% (preferably from about 2.5% to about 10%, more preferably from about 3.0% to about 8.0%, even more preferably from about 3.5% to about 7.0%) by weight of at least one arylborono-containing vinylic monomer having an arylborono group, (vi) at least one non-silicone vinylic crosslinker, (vii) at least one free-radical initiator, and (viii) optionally at least one solvent selected from the group consisting of water, propylene glycol, a polyethyleneglycol having a molecular weight of about 400 Daltons or less, and combinations thereof. The sum of the amounts of components (i) to (vii) is at least about 90% by weight, preferably at least about 92% by weight, more preferably at least about 94% by weight, even more preferably at least about 96% by weight relative to the total amount of all polymerizable components in the polymerizable composition. It is understood that according to this preferred embodiment of the invention, the polymerizable composition can further comprise one or more additional polymerizable components (other than components (i) to (v) known to a person skilled in the art, so long as the sum of the amounts of those additional polymerizable component components is about 10% by weight or less, preferably about 8% by weight or less, more preferably about 6% by weight or less, even more preferably about 4% by weight or less, relative to the total amount of all polymerizable components in the polymerizable composition. The polymerizable composition can be prepared by blending all of the desirable components as known to a person skilled in the art.

In accordance with the invention, the polymerizable composition can be dispensed into the lens mold according to any known techniques. For example, a specific amount of a polymerizable composition is typically dispensed into a female mold half by means of a dispensing device and then a male mold half is put on and the mold is closed. As the mold closes, any excess polymerizable composition is pressed into an overflow provided on the female mold half (or alternatively on the male mold half).

The molding assembly (i.e., the closed mold containing the polymerizable composition) is subsequently cured thermally or actinically, as known to a person skilled in the art, to form a preformed silicone hydrogel lens comprising a bulk silicone hydrogel material that comprises carboxyl groups and arylborono groups. It is understood that carboxyl groups on and/or near the surface of the bulk silicone hydrogel material can serve as reactive sites at which a layer of a crosslinked hydrophilic polymeric material can be covalently attached, whereas arylborono groups on and/or near the surface of the bulk silicone hydrogel material can serve as reactive sites at which a diol-containing hydrophilic polymer having 1,2- or 1,3-diol moieties can be covalently attached.

After curing, the molds can be opened according to any techniques known to a person skilled in the art. After the mold is separated, the preformed silicone hydrogel lens adheres to one of the male and female mold halves.

The preformed silicone hydrogel lens adhered on the lens-adhered mold half can be removed from the lens-adhered mold half and then subject to one or more post molding processes.

In accordance with the invention, an aqueous coating solution of the invention must comprises two different types of coating materials.

The first type of coating materials is water-soluble and thermally-crosslinkable hydrophilic polymeric materials that are branched or slightly-crosslinked and comprises thermally crosslinkable groups (azetidinium groups and/or epoxide groups) and optionally but preferably reactive functional groups (primary amino groups, secondary amino groups, carboxylic acid groups, thiol groups, or combinations thereof).

The term “slightly-crosslinked” in reference to a polymeric material means that the number of crosslinks between polymer chains in the polymeric material is so low that the polymeric material is still water soluble.

In a preferred embodiment, a water-soluble, thermally crosslinkable hydrophilic is a partially-crosslinked polymeric material that comprises a three-dimensional network and thermally-crosslinkable groups, preferably azetidinium groups, within the network or being attached to the network. The term “partially-crosslinked” in reference to a polymeric material means that the crosslinkable groups of starting materials for making the polymeric material in crosslinking reaction have not been fully consumed. For example, such a thermally-crosslinkable hydrophilic polymeric material comprises azetidinium groups and is a partial reaction product of at least one azetidinium-containing or epoxide-containing polymer with at least one hydrophilicity-enhancing agent (i.e., a wetting agent) having at least one carboxyl, primary amine, secondary amine, or thiol group, according to the crosslinking reactions shown in Scheme I

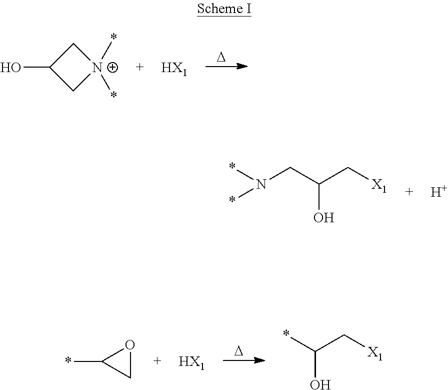

in which X, is —S—*, —OC(═O)—*, or —NR′—* in which R′ is hydrogen or a C₁-C₂₀ unsubstituted or substituted alkyl group, and * represents an organic radical.

Examples of preferred water-soluble and thermally-crosslinkable hydrophilic polymeric materials comprising epoxide groups include without limitation: one or more multi-armed polyethylene glycols each having terminal epoxide (i.e., epoxy) groups; a partial reaction product of a multi-armed polyethylen glycol having terminal epoxide group with one or more polyethylene glycol each having terminal functional groups selected from the group consisting of primary amine groups, secondary amine groups, carboxyl groups, thiol groups, and combinations thereof; a partial reaction product of a multi-armed polyethylene having terminal epoxide groups with a hydrophilicity-enhancing agent having at least one reactive functional group selected from the group consisting of amino group, carboxyl group, thiol group, and combination thereof (as disclosed in U.S. Pat. No. 9,505,184, hydrophilic polymers disclosed in U.S. Pat. No. 6,440,571); a partial reaction product of a copolymer of an epoxide-containing vinylic monomer (any one of those described above) and one or more hydrophilic vinylic monomer with a hydrophilicity-enhancing agent having at least one reactive functional group selected from the group consisting of amino group, carboxyl group, thiol group, and combination thereof (any one of those described later); a copolymer of an epoxide-containing vinylicmonomer (any one of those described above), a hydrophilic vinylic monomer, a C₁-C₄-alkoxy poly(ethylene glycol)ethyl (meth)acrylate having a number average molecular weight of up to 2500 Daltons (poly(ethylene glycol)ethyl (meth)acrylate having a number average molecular weight of up to 2500 Daltons, C₁-C₄-alkoxy poly(ethylene glycol)ethyl (meth)acrylamide, or poly(ethylene glycol)ethyl (meth)acrylamide having a number average molecular weight of up to 2500 Daltons); or combinations thereof.

Examples of preferred water-soluble and thermally-crosslinkable hydrophilic polymeric materials comprising azetidinium groups include without limitation poly(2-oxazoline-co-ethyleneimine)-epichlorohydrin copolymers which are disclosed in U.S. Pat. No. 9,720,138, chemically-modified poly(2-oxazoline-co-ethyleneimine)-epichlorohydrin copolymers which are disclosed in U.S. Pat. No. 9,720,138, chemically-modified polyamidoamine-epichlorohydrins as disclosed in U.S. Pat. No. 8,529,057, copolymers of an azetidinium-containing vinylic monomer with one or more hydrophilic vinylic monomers disclosed in U.S. Pat. No. 9,422,447, chemically-modified copolymers of an azetidinium-containing vinylic monomer with one or more hydrophilic vinylic monomers disclosed in U.S. Pat. No. 9,422,447, or combinations thereof.

In accordance with the invention, the term “chemically-modified” in reference with a water-soluble and thermally crosslinkable hydrophilic polymeric material having azetidinium groups means that a poly(2-oxazoline-co-ethyleneimine)-epichlorohydrin copolymer, a polyamidoamine-epichlorohydrin or a copolymer of an azetidinium-containing vinylic monomer is reacted partially (i.e., not consuming all of the azetidinium groups) with a hydrophilicity-enhancing agent having at least one reactive functional group selected from the group consisting of amino group, carboxyl group, thiol group, and combination thereof. A chemically-modified poly(2-oxazoline-co-ethyleneimine)-epichlorohydrin copolymer or polyamidoamine-epichlorohydrin or copolymer of an azetidinium-containing vinylic monomer can be especially useful for forming relatively-thick and soft non-silicone hydrogel coatings on silicone hydrogel contact lenses.

Any suitable hydrophilicity-enhancing agents can be used in the invention so long as they contain at least one amino group, at least one carboxyl group, and/or at least one thiol group.

A preferred class of hydrophilicity-enhancing agents include without limitation: primary amino-, secondary amino-, carboxyl- or thiol-containing monosaccharides (e.g., 3-amino-1,2-propanediol, 1-thiolglycerol, 5-keto-D-gluconic acid, galactosamine, glucosamine, galacturonic acid, gluconic acid, glucosaminic acid, mannosamine, saccharic acid 1,4-lactone, saccharide acid, Ketodeoxynonulosonic acid, N-methyl-D-glucamine, 1-amino-1-deoxy-β-D-galactose, 1-amino-1-deoxysorbitol, 1-methylamino-1-deoxysorbitol, N-aminoethyl gluconamide); primary amino-, secondary amino-, carboxyl- or thiol-containing disaccharides (e.g., chondroitin disaccharide sodium salt, di(β-D-xylopyranosyl)amine, digalacturonic acid, heparin disaccharide, hyaluronic acid disaccharide, Lactobionic acid); and primary amino-, secondary amino-, carboxyl- or thiol-containing oligosaccharides (e.g., carboxymethyl-β-cyclodextrin sodium salt, trigalacturonic acid); and combinations thereof.

Another preferred class of hydrophilicity-enhancing agents is hydrophilic polymers having one or more (primary or secondary) amino, carboxyl and/or thiol groups. More preferably, the content of the amino (—NHR′ with R′ as defined above), carboxyl (—COOH) and/or thiol (—SH) groups in a hydrophilic polymer as a hydrophilicity-enhancing agent is less than about 40%, preferably less than about 30%, more preferably less than about 20%, even more preferably less than about 10%, by weight based on the total weight of the hydrophilic polymer.

One preferred class of hydrophilic polymers as hydrophilicity-enhancing agents are (primary or secondary) amino- or carboxyl-containing polysaccharides, for example, such as, carboxymethylcellulose (having a carboxyl content of about 40% or less, which is estimated based on the composition of repeating units, —[C₆H₁₀₋ₘO₅(CH₂CO₂H)ₘ]— in which m is 1 to 3), carboxyethylcellulose (having a carboxyl content of about 36% or less, which is estimated based on the composition of repeating units, —[C₆H₁₀₋ₘO₅(C₂H₄CO₂H)ₘ]— in which m is 1 to 3) carboxypropylcellulose (having a carboxyl content of about 32% or less, which is estimated based on the composition of repeating units, —[C₆H₁₀₋ₘO₅(C₃H₆CO₂H)ₘ]—, in which m is 1 to 3), hyaluronic acid (having a carboxyl content of about 11%, which is estimated based on the composition of repeating units, —(C₁₃H₂₀O₉NCO₂H)—), chondroitin sulfate (having a carboxyl content of about 9.8%, which is estimated based on the composition of repeating units, —(C₁₂H₁₈O₁₃NSCO₂H)—), or combinations thereof.

Another preferred class of hydrophilic polymers as hydrophilicity-enhancing agents include without limitation: poly(ethylene glycol) (PEG) with mono-amino (primary or secondary amino), carboxyl or thiol group (e.g., PEG-NH₂, PEG-SH, PEG-COOH); H₂N-PEG-NH₂; HOOC-PEG-COOH; HS-PEG-SH; H₂N-PEG-COOH; HOOC-PEG-SH; H₂N-PEG-SH; multi-arm PEG with one or more amino (primary or secondary), carboxyl or thiol groups; PEG dendrimers with one or more amino (primary or secondary), carboxyl or thiol groups; a diamino-(primary or secondary) or dicarboxyl-terminated homo- or co-polymer of a non-reactive hydrophilic vinylic monomer; a monoamino- (primary or secondary) or monocarboxyl-terminated homo- or co-polymer of a non-reactive hydrophilic vinylic monomer; a copolymer which is a polymerization product of a composition comprising (1) about 60% by weight or less, preferably from about 0.1% to about 30%, more preferably from about 0.5% to about 20%, even more preferably from about 1% to about 15%, by weight of one or more reactive vinylic monomers and (2) at least one non-reactive hydrophilic vinylic monomer; and combinations thereof. Reactive vinylic monomer(s) and non-reactive hydrophilic vinylic monomer(s) are those described previously.

In accordance with the invention, reactive vinylic monomers for making hydrophilicity-enhancing agents can be carboxyl-containing vinylic monomers (those described above), primary and secondary amino-containing vinylic monomers (those described above).

In accordance with the invention, a non-reactive vinylic monomer for making hydrophilicity-enhancing agents is a vinylic monomer free of any carboxyl group, primary amino group, secondary amino group, epoxide group, isocyanate group, azlactone group, or aziridine group. Non-reactive vinylic monomers preferably are non-charged hydrophilic vinylic monomers which are free of carboxyl or amino group (any those described above can be used here), phosphorylcholine-containing vinylic monomers (any those described above can be used here), or combinations thereof.

More preferably, a hydrophilic polymer as a hydrophilicity-enhancing agent is:
a poly(ethylene glycol) having one sole functional group of —NH₂, —SH or —COOH;
a poly(ethylene glycol) having two terminal functional groups selected from the group consisting of —NH₂, —COOH, —SH, and combinations thereof;
a multi-arm poly(ethylene glycol) having one or more functional groups selected from the group consisting of —NH₂, —COOH, —SH, and combinations thereof;
a monoamino-, monocarboxyl-, diamino- or dicarboxyl-terminated homo- or copolymer of a non-reactive hydrophilic vinylic monomer;
a copolymer which is a polymerization product of a composition comprising (1) from about 0.1% to about 30%, preferably from about 0.5% to about 20%, more preferably from about 1% to about 15%, by weight of a reactive vinylic monomer and (2) at least one non-reactive vinylic monomer,

Examples of preferred reactive vinylic monomers include those described above.

Example of preferred non-reactive hydrophilic vinylic monomers include without limitation (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, N-2-dimethylaminoethyl (meth)acrylamide, dimethylaminoethyl (meth)acrylate, hydroxyl-containing acrylic monomers (any one described above), N-vinyl amide monomers (any one described above), methylene-containing pyrrolidone monomers (i.e., pyrrolidone derivatives each having a methylene group connected to the pyrrolidone ring at 3- or 5-position) (any one described above), acrylic monomers having a C₁-C₄ alkoxyethoxy group (any one described above), vinyl ether monomers (any one described above), allyl ether monomers (any one described above), a phosphorylcholine-containing vinylic monomer (any one described above), and combinations thereof.

Preferably, the non-reactive hydrophilic vinylic monomer is selected from the group consisting of (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)ethylphosphate, 3-[(meth)acryloylamino]propyl-2′-(trimethylammonio)ethylphosphate, 4-[(meth)acryloylamino]butyl-2′-(trimethylammonio)ethyl-phosphate, (meth)acrylamide, dimethyl (meth)acrylamide, N-2-hydroxylethyl (meth)acrylamide, N,N-bis(hydroxyethyl) (meth)acrylamide, N-2,3-dihydroxypropyl (meth)acrylamide, N-tris(hydroxymethyl)methyl (meth)acrylamide, 2-hydroxyethyl (meth)acrylate, glycerol methacrylate (GMA), tetra(ethylene glycol) (meth)acrylate, poly(ethylene glycol)ethyl (meth)acrylamide having a number average molecular weight of up to 1500, poly(ethylene glycol) (meth)acrylate having a number average molecular weight of up to 1500, N-vinylpyrrolidone, N-vinyl-N-methyl acetamide, N-vinyl formamide, N-vinyl acetamide, 1-methyl-3-methylene-2-pyrrolidone, 1-methyl-5-methylene-2-pyrrolidone, 5-methyl-3-methylene-2-pyrrolidone, tetra(ethylene glycol) methyl ether (meth)acrylate, methoxypoly(ethylene glycol)ethyl (meth)acrylamide having a number average molecular weight of up to 1500, C₁-C₄-alkoxy polyethylene glycol (meth)acrylate having a weight average molecular weight of up to 1500, tetra(ethylene glycol) monovinyl ether, poly(ethylene glycol) monovinyl ether, tetra(ethylene glycol) methyl vinyl ether, poly(ethylene glycol) methyl vinyl ether, tetra(ethylene glycol) monoallyl ether, poly(ethylene glycol) monoallyl ether, tetra(ethylene glycol) methyl allyl ether, poly(ethylene glycol) methyl allyl ether, vinyl alcohol, allyl alcohol, and combinations thereof, more preferably selected from the group consisting of (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)ethyl-phosphate, 3-[(meth)acryloylamino]propyl-2′-(tri methylammonio)ethylphosphate, 4-[(meth)acryloylamino]butyl-2′-(trimethylammonio)ethylphosphate, (meth)acrylamide, dimethyl (meth)acrylamide, N-2-hydroxylethyl (meth)acrylamide, N,N-bis(hydroxyethyl) (meth)acrylamide, N-2,3-dihydroxypropyl (meth)acrylamide, N-tris(hydroxymethyl)methyl (meth)acrylamide, 2-hydroxyethyl (meth)acrylate, glycerol methacrylate (GMA), poly(ethylene glycol)ethyl (meth)acrylamide having a number average molecular weight of up to 1500, poly(ethylene glycol) (meth)acrylate having a number average molecular weight of up to 1500, N-vinylpyrrolidone, N-vinyl-N-methyl acetamide, methoxypoly(ethylene glycol)ethyl (meth)acrylamide having a number average molecular weight of up to 1500, methoxy polyethylene glycol (meth)acrylate having a weight average molecular weight of up to 1500, poly(ethylene glycol) monovinyl ether, poly(ethylene glycol) methyl vinyl ether, poly(ethylene glycol) monoallyl ether, poly(ethylene glycol) methyl allyl ether, vinyl alcohol, allyl alcohol, and combinations thereof, even more preferably selected from the group consisting of (meth)acryloyloxyethyl phosphorylcholine, (meth)acryloyloxypropyl phosphorylcholine, 2-[(meth)acryloylamino]ethyl-2′-(trimethylammonio)ethylphosphate, 3-[(meth)acryloylamino]propyl-2′-(trimethylammonio)ethylphosphate, (meth)acrylamide, dimethyl (meth)acrylamide, N-2-hydroxyethyl (meth)acrylamide, N,N-bis(hydroxyethyl) (meth)acrylamide, N-2,3-dihydroxypropyl (meth)acrylamide, N-tris(hydroxymethyl)methyl (meth)acrylamide, poly(ethylene glycol)ethyl (meth)acrylamide having a number average molecular weight of up to 1500, poly(ethylene glycol) (meth)acrylate having a number average molecular weight of up to 1500, N-vinylpyrrolidone, N-vinyl-N-methyl acetamide, methoxypoly(ethylene glycol)ethyl (meth)acrylamide having a number average molecular weight of up to 1500, methoxy polyethylene glycol (meth)acrylate having a weight average molecular weight of up to 1500, and combinations thereof.

PEGs with functional groups and multi-arm PEGs with functional groups can be obtained from various commercial suppliers, e.g., Polyscience, and Shearwater Polymers, inc., etc.

Monoamino-, monocarboxyl-, diamino- or dicarboxyl-terminated homo- or copolymers of one or more non-reactive hydrophilic vinylic monomers or of a phosphorylcholine-containing vinylic monomer can be prepared according to procedures described in U.S. Pat. No. 6,218,508, herein incorporated by reference in its entirety. For example, to prepare a diamino- or dicarboxyl-terminated homo- or co-polymer of a non-reactive hydrophilic vinylic monomer, the non-reactive vinylic monomer, a chain transfer agent with an amino or carboxyl group (e.g., 2-aminoethanethiol, 2-mercaptopropinic acid, thioglycolic acid, thiolactic acid, or other hydroxymercaptanes, aminomercaptans, or carboxyl-containing mercaptanes) and optionally other vinylic monomer are copolymerized (thermally or actinically) with a reactive vinylic monomer (having an amino or carboxyl group), in the presence of an free-radical initiator. Generally, the molar ratio of chain transfer agent to that of all of vinylic monomers other than the reactive vinylic monomer is from about 1:5 to about 1:100, whereas the molar ratio of chain transfer agent to the reactive vinylic monomer is 1:1. In such preparation, the chain transfer agent with amino or carboxyl group is used to control the molecular weight of the resultant hydrophilic polymer and forms a terminal end of the resultant hydrophilic polymer so as to provide the resultant hydrophilic polymer with one terminal amino or carboxyl group, while the reactive vinylic monomer provides the other terminal carboxyl or amino group to the resultant hydrophilic polymer. Similarly, to prepare a monoamino- or monocarboxyl-terminated homo- or co-polymer of a non-reactive hydrophilic vinylic monomer, the non-reactive vinylic monomer, a chain transfer agent with an amino or carboxyl group (e.g., 2-aminoethanethiol, 2-mercaptopropinic acid, thioglycolic acid, thiolactic acid, or other hydroxymercaptanes, aminomercaptans, or carboxyl-containing mercaptanes) and optionally other vinylic monomers are copolymerized (thermally or actinically) in the absence of any reactive vinylic monomer.

Copolymers comprising a non-reactive hydrophilic vinylic monomer and a reactive vinylic monomer (e.g., a carboxyl-containing vinylic monomer, a primary amino group-containing vinylic monomer or a secondary amino group-containing vinylic monomer) can be prepared according to any well-known radical polymerization methods or obtained from commercial suppliers. Copolymers containing methacryloyloxyethyl phosphorylcholine and carboxyl-containing vinylic monomer (or amino-containing vinylic monomer) can be obtained from NOP Corporation (e.g., LIPIDURE®-AC01, and AE).

The weight average molecular weight M_{w} of the hydrophilic polymer having at least one amino, carboxyl or thiol group (as a hydrophilicity-enhancing agent) is preferably from about 500 to about 2,000,000, more preferably from about 1,000 to about 500,000, even more preferably from about 5,000 to about 250,000 Daltons.

Water-soluble and thermally-crosslinkable hydrophilic polymeric materials can be prepared according to the processes disclosed in U.S. Pat. Nos. 8,529,057, 9,422,447, 9,720,138, and 11256003 and in U.S. Pat. Appl. Ser. No. 63/371,660.

In a preferred embodiment, a water-soluble thermally-crosslinkable polymeric material can be obtained by heating an aqueous reactive solution, which comprises at least one azetidinium-containing polymer and at least one hydrophilicity-enhancing agent (i.e., a wetting agent) having at least one reactive functional group selected from the group consisting of amino group, carboxyl group, thiol group, and a combination thereof, to a temperature of from about 35° C. to about 85° C. and maintaining the temperature for a period of time sufficient (about 8 hours or less, preferably about 5 hours, more preferably from about 2 hour to about 4 hours). The aqueous reactive solution preferably comprises from about 70 mM to about 170 mM (preferably about 90 mM to about 150 mM, more preferably from about 100 mM to about 130 mM) of one or more ionic compounds and a pH of at least 8.0 (preferably at least 8.5, more preferably at least 9.0, even more preferably at least 9.5). It should be understood that the reaction time should be long enough to covalently attach the hydrophilicity-enhancing agent onto the polymer chain of the azetidinium-containing polymer, but should be short enough not to consume all the azetidinium groups of the azetidinium-containing polymer and not to form a gel (i.e., not water-soluble) due to the too many crosslinkages formed between the azetidinium-containing polymer and the hydrophilicity-enhancing agent. A resultant polymeric material is a lightly-crosslinked polymeric material which has a highly-branched structure and still comprises thermally-crosslinkable azetidinium groups.

A person skilled in the art understands well how to adjust the pH of the reactive mixture, e.g., by adding a base (e.g., NaOH, KOH, NH₄OH, or mixture thereof) or an acid (e.g., HCl, H₂SO₄, H₃PO₄, citric acid, acetic acid, boric acid, or mixture thereof).

In accordance with the invention, any ionic compounds can be used in the reactive mixture. Preferably, ionic compounds are those used as ionic tonicity-adjusting agents and ionic buffering agents used in an ophthalmic solutions. Examples of preferred ionic tonicity-adjusting agents includes without limitation sodium chloride, potassium chloride, and combinations thereof. Examples of preferred ionic buffering agents includes various salts of phosphoric acid (e.g. NaH₂PO₄, Na₂HPO₄, Na₃PO₄, KH₂PO₄, K₂HPO₄, K₃PO₄, or mixtures thereof), various salts of boric acid (e.g., sodium borate, potassium borate, or mixture thereof), various salts of citric acid (e.g., monosodium citrate, disodium citrate, trisodium citrate, monopotassium citrate, dipotassium citrate, tripotassium citrate, or mixtures thereof), various salts of carbonic acid (e.g., Na₂CO₃, NaHCO₃, K₂CO₃, KHCO₃, or mixture thereof).

The aqueous reactive solution for preparing a water-soluble thermally-crosslinkable polymeric material can be prepared by dissolving a desired amount of an azetidinium-containing polymer, a desired amount of a hydrophilicity-enhancing agent with at least one reactive functional group, and desired amounts of other components (e.g., ionic buffering agents, ionic tonicity-adjusting agents, etc.) in water (or a mixture of water and a minority amount of a water-soluble organic solvent) to form an aqueous solution and then adjusting the pH of the aqueous solution if necessary.

In accordance with the invention, the concentration ratio of a hydrophilicity-enhancing agent relative to an azetidinium-containing polymer in the aqueous reactive solution must be selected not to render a resultant water-soluble thermally-crosslinkable polymeric material water-insoluble (i.e., a solubility of less than 0.005 g per 100 ml of water at room temperature) and not to consume more than about 99%, preferably about 98%, more preferably about 97%, even more preferably about 96% of the azetidinium groups of the azetidinium-containing polymer.

In a preferred embodiment, the aqueous reactive solution comprises from 0.01% to about 10% by weight (preferably from 0.05% to about 5% by weight, more preferably from 0.08% to about 1% by weight, even more preferably from 0.1% to about 0.4% by weight) of an azetidinium-containing polymer and from about 0.01% to about 10% by weight (preferably from 0.02% to about 5% by weight, more preferably from 0.05% to about 2% by weight, even more preferably from 0.08% to about 1.0% by weight) of a hydrophilicity-enhancing agent having at least one reactive function group (carboxyl, primary amino, secondary amino group), the concentration ratio of the azetidinium-containing polymer to the hydrophilicity-enhancing agent is from about 1000:1 to 1:1000 (preferably from about 500:1 to about 1:500, more preferably from about 250:1 to about 1:250, even more preferably from about 100:1 to about 1:100).

In a preferred embodiment, the water-soluble thermally-crosslinkable polymeric material comprises (i) from about 20% to about 95% by weight of first polymer chains derived from a polyamidoamine-epichlorohydrin or a poly(2-oxazoline-co-ethyleneimine)-epichlorohydrin, (ii) from about 5% to about 80% by weight of hydrophilic moieties or second polymer chains derived from at least one hydrophilicity-enhancing agent having at least one reactive functional group selected from the group consisting of amino group, carboxyl group, thiol group, and combination thereof (preferably carboxyl or thiol groups), wherein the hydrophilic moieties or second polymer chains are covalently attached to the first polymer chains through one or more covalent linkages each formed between one azetidinium group of the polyamidoamine-epichlorohydrin or the poly(2-oxazoline-co-ethyleneimine)-epichlorohydrin and one amino, carboxyl or thiol group of the hydrophilicity-enhancing agent, and (iii) azetidinium groups which are parts of the first polymer chains or pendant or terminal groups covalently attached to the first polymer chains. The composition of a chemically-modified poly(2-oxazoline-co-ethyleneimine)-epichlorohydrin or a chemically-modified polyamidoamine-epichlorohydrin is determined by the composition (based on the total weight of the reactants) of a reactant mixture used for such a polymer according to the crosslinking reactions shown in Scheme I above. For example, if a reactant mixture comprises about 75% by weight of a polyamidoamine-epichlorohydrin and about 25% by weight of at least one hydrophilicity-enhancing agent based on the total weight of the reactants, then the resultant chemically-modified polyamidoamine-epichlorohydrin comprises about 75% by weight of first polymer chains derived from the polyamioamine-epichlorohydrin and about 25% by weight of hydrophilic moieties or second polymer chains derived from said at least one hydrophilicity-enhancing agent.

In accordance with the invention, the second type of coating materials is diol-containing hydrophilic polymers that comprises 1,2- or 1,3-diol moieties. Any diol-containing hydrophilic polymers having 1,2- or 1,3-diol moieties can be used in the invention. Examples of preferred diol-containing hydrophilic polymers having 1,2- or 1,3-diol moieties include without limitation polyvinyl alcohol, poly(ethylene glycol)-graft-poly(vinyl alcohol), a copolymer of vinyl alcohol and a hydrophilic vinylic monomer, a copolymer of glycerol (meth)acrylate with a hydrophilic vinylic monomer, a copolymer of 2,3,4-trihydroxybutyl (meth)acrylate and a hydrophilic vinylic monomer, a copolymer of 2,2-dihydroxypropyl (meth)acrylate and a hydrophilic vinylic monomer, a copolymer of 2,3-dihydroxybutyl (meth)acrylate and a hydrophilic vinylic monomer, a copolymer of glycerin-2 (meth)acrylate and a hydrophilic vinylic monomer, a copolymer of N-2,3-dihydroxypropyl (meth)acrylamide and a hydrophilic vinylic monomer, a copolymer of 3-allyloxy-1,2-propanediol and a hydrophilic vinylic monomer, and combinations thereof.

In accordance with the invention, during the heating step, said at least one water-soluble, thermally-crosslinkable hydrophilic polymeric material is crosslinked according to inter- and intra-molecular crosslinking reactions between azetidinium or epoxide group and carboxyl or amino or thiol group and also covalently attached onto the bulk silicone hydrogel material according to reaction between azetidinium or epoxide group and carboxyl group, whereas the diol-containing hydrophilic polymer is covalently attached onto the bulk silicone hydrogel material according to reaction between arylborono group and 1,2- or 1,3-diol moiety.

Preferably, the step of heating is performed by autoclaving the preformed SiHy contact lens immersed in a packaging solution (i.e., a buffered aqueous coating solution) in a sealed lens package at a temperature of from about 115° C. to about 125° C. for approximately 20-90 minutes.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

In accordance with the invention, a packaging solution contains at least one buffering agent and one or more other ingredients known to a person skilled in the art. Examples of other ingredients include without limitation, tonicity agents, surfactants, antibacterial agents, preservatives, and lubricants (e.g., cellulose derivatives, polyvinyl alcohol, polyvinyl pyrrolidone).

The packaging solution contains a buffering agent in an amount sufficient to maintain a pH of the packaging solution in the desired range, for example, preferably from about 6.8 to about 8.5, more preferably from about 7.0 to 8.2, even more preferably from about 7.2 to about 8.0. It is found that a higher pH is desirable for ensuring that all or a significant portion of the carboxyl groups of the bulk silicone hydrogel material are ionized. As a result, the resultant silicone hydrogel contact lenses become dimensionally stable in the packaging solution during autoclave and storage and can have improved lubricity.

Any known, physiologically compatible buffering agents can be used. Suitable buffering agents as a constituent of the contact lens care composition according to the invention are known to a person skilled in the art. Preferably, a phosphate buffer (consisting essentially of a mixture of a monobasic dihydrogen phosphate (e.g., NaH₂PO₄, KH₂PO₄, or mixtures thereof) and dibasic monohydrogen phosphate (e.g., Na₂HPO₄, K₂HPO₄, or mixtures thereof) are used for maintaining the pH of the the packaging solution. In various preferred embodiments, the total concentration of the monobasic dihydrogen phosphate and the dibasic monohydrogen phosphate is at least 30 mM (preferably at least 35 mM, more preferably at least 40 mM, even more preferably at least 45 mM).

The solutions according to the invention are preferably formulated in such a way that they are isotonic with the lachrymal fluid. A solution which is isotonic with the lachrymal fluid is generally understood to be a solution whose concentration corresponds to the concentration of a 0.9% sodium chloride solution (308 mOsm/kg). Deviations from this concentration are possible throughout.

The isotonicity with the lachrymal fluid, or even another desired tonicity, may be adjusted by adding organic or inorganic substances that affect the tonicity. Suitable occularly acceptable tonicity agents include, but are not limited to sodium chloride, potassium chloride, glycerol, propylene glycol, polyols, mannitols, sorbitol, xylitol and mixtures thereof. The tonicity of the packaging solution is typically adjusted to be from about 200 to about 450 milliosmol (mOsm), preferably from about 250 to 350 mOsm.

In a preferred embodiment, one or more organic tonicity agents (e.g., glycerol, propylene glycol, polyethylene glycol having a number average molecular weigh of from 200 to 800 daltons), mannitols, sorbitol, xylitol, and mixtures thereof) are is present in an amount of at least 70 mM (preferably at least 90 mM, more preferably at least 110 mM, even more preferably at least 130 mM) for adjusting the tonicity of the packaging solution. It is found that the resultant silicone hydrogel contact lenses can have improved lubricity when the ionic strength of the packaging solution is lowered (e.g., by replacing a portion of NaCl with an organic tonicity agent, e.g., propylene glycol).

In a preferred embodiment, the packaging solution comprises preferably from about 0.01% to about 2%, more preferably from about 0.05% to about 1.5%, even more preferably from about 0.1% to about 1%, most preferably from about 0.2% to about 0.5%, by weight of a water-soluble thermally-crosslinkable hydrophilic polymeric material having azetidinium groups.

In another aspect, the invention provides a coated silicone hydrogel contact lens comprising a bulk silicone hydrogel material and a non-silicone hydrogel coating thereon, wherein the bulk silicone hydrogel material comprises (a) repeating units of at least one polysiloxane vinylic crosslinker and/or at least one siloxane-containing vinylic monomer, (b) repeating units of at least one carboxyl-containing vinylic monomer relative to the total amount of all polymerizable components, (c) repeating units of at least one hydrophilic vinylic monomer, (d) repeating units of at least one arylborono-containing vinylic monomer having an arylborono group; (e) optionally but preferably repeating units of at least one non-silicone vinylic crosslinker, wherein the non-silicone hydrogel coating comprises a crosslinked polymeric material and a grafted hydrophilic polymer that is distributed in but not covalently bonded to the crosslinked polymeric material, wherein the crosslinked hydrophilic polymeric material is covalently attached to the bulk silicone hydrogel material through first linkages each formed between one carboxylic acid group and one azetidinium or epoxide group, wherein the grafted hydrophilic polymer comprises 1,2- and/or 1,3-diol moieties and is covalently attached to the bulk silicone hydrogel material through second linkages each formed between one arylboronoc group and one 1,2- or 1,3-diol moiety, wherein the coated silicone hydrogel contact lens in fully hydrated state exhibits a coating intactness of about 90% or higher (preferably about 93% or higher, more preferably about 96% or higher, even more preferably about 98% or higher) and a friction rating of about 2.0 or lower (preferably about 1.5 or lower, more preferably about 1.0 or lower, even more preferably about 0.5 or lower).

The various embodiments including preferred embodiments of bulk SiHy materials, polysiloxane vinylic crosslinkers, siloxane-containing vinylic monomers, carboxyl-containing vinylic monomers, hydrophilic vinylic monomers, arylborono-containing vinylic monomers, non-silicone vinylic crosslinkers, water-soluble and thermally-crosslinkable hydrophilic polymeric materials, and hydrophilic polymers having 1,2- or 1,3-diol moieties have beeb described above and can be used in this aspect of the invention.

Although various embodiments of the invention have been described using specific terms, devices, and methods, such description is for illustrative purposes only. The words used are words of description rather than of limitation. As would be obvious to one skilled in the art, many variations and modifications of the invention may be made by those skilled in the art without departing from the spirit and scope of the novel concepts of the disclosure. In addition, it should be understood that aspects of the various embodiments of the invention may be interchanged either in whole or in part or can be combined in any manner and/or used together, as illustrated below:

1. A coated silicone hydrogel contact lens comprising:
a bulk silicone hydrogel material and a non-silicone hydrogel coating thereon, wherein the bulk silicone hydrogel material comprises (a) repeating units of at least one polysiloxane vinylic crosslinker and/or at least one siloxane-containing vinylic monomer, (b) repeating units of at least one carboxyl-containing vinylic monomer relative to the total amount of all polymerizable components, (c) repeating units of at least one hydrophilic vinylic monomer, (d) repeating units of at least one arylborono-containing vinylic monomer having an arylborono group, and (e) optionally but preferably repeating units of at least one non-silicone vinylic crosslinker,
wherein the non-silicone hydrogel coating comprises a crosslinked polymeric material and a grafted hydrophilic polymer that is distributed in but not covalently bonded to the crosslinked polymeric material, wherein the crosslinked hydrophilic polymeric material is covalently attached to the bulk silicone hydrogel material through first linkages each formed between one carboxylic acid group and one azetidinium or epoxide group, wherein the grafted hydrophilic polymer comprises 1,2- and/or 1,3-diol moieties and is covalently attached to the bulk silicone hydrogel material through second linkages each formed between one arylboronoc group and one 1,2- or 1,3-diol moiety,
wherein the coated silicone hydrogel contact lens in fully hydrated state exhibits a coating intactness of about 90% or higher and a friction rating of about 2.0 or lower.

2. The coated silicone hydrogel contact lens of embodiment 1, wherein the coated silicone hydrogel contact lens in fully hydrated state exhibits a coating intactness of about 93% or higher.

3. The coated silicone hydrogel contact lens of embodiment 1, wherein the coated silicone hydrogel contact lens in fully hydrated state exhibits a coating intactness of about 96% or higher.

4. The coated silicone hydrogel contact lens of embodiment 1, wherein the coated silicone hydrogel contact lens in fully hydrated state exhibits a coating intactness of about 98% or higher.

5. The coated silicone hydrogel contact lens of any one of embodiments 1 to 4, wherein the coated silicone hydrogel contact lens in fully hydrated state exhibits a friction rating of about 1.5 or lower.

6. The coated silicone hydrogel contact lens of any one of embodiments 1 to 4, wherein the coated silicone hydrogel contact lens in fully hydrated state exhibits a friction rating of about 1.0 or lower.

7. The coated silicone hydrogel contact lens of any one of embodiments 1 to 4, wherein the coated silicone hydrogel contact lens in fully hydrated state exhibits a friction rating of about 0.5 or lower.

8. The coated silicone hydrogel contact lens of any one of embodiments 1 to 7, wherein said at least one carboxyl-containing vinylic monomer is selected from the group consisting of acrylic acid, C₁-C₄ alkylacrylic acid, (meth)acrylox-C₁-C₆ alkanoic acid, mono-2-[(meth)acryloxy]-ethyl succinate, 2-acrylamidoglycolic acid, (meth)acrylamido-C₁-C₆ alanoic acid, and combinations thereof.

9. The coated silicone hydrogel contact lens of any one of embodiments 1 to 8, wherein said at least one arylborono-containing vinylic monomer is represented by formula (I)

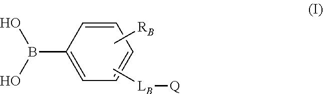

in which: R_{B} is a monovalent radical (preferably is H, NO₂, F, Cl, Br, CF₃, CH₂OH, or CH₂NR^{o}R^{o′}
in which R^{o} and R^{o′} independent of each other are H or C₁-C₄ alkyl); Q is a monovalent radical of

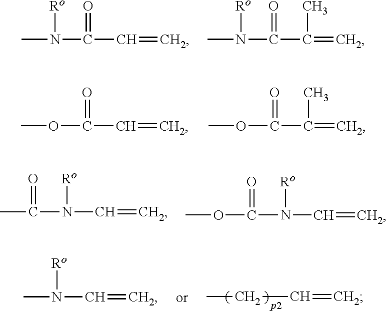

L_{B} is a direct bond, a C₁-C₄ alkylene divalent radical, a divalent radical of

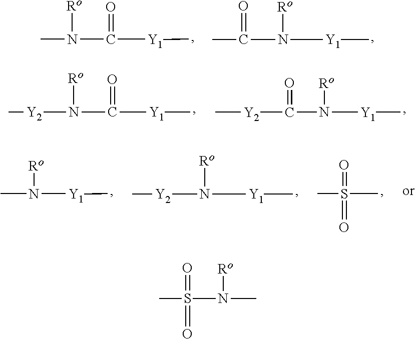

in which Y₁ is CH(OH) or a C₁-C₄ alkylene divalent radical, Y₂ is a C₁-C₄ alkylene divalent radical, p2 is an integer of 0 to 3, and R^{o} is H or a C₁-C₄ alkyl.

10. The coated silicone hydrogel contact lens of any one of embodiments 1 to 8, wherein said at least one arylborono-containing vinylic monomer comprises 3-vinylphenylboronic acid, 4-vinylphenylboronic acid, 3-(meth)acrylamidophenylboronic acid, 4-(meth)acrylamido-phenylboronic acid, 4-(1,6-dioxo-2,5-diaza-7-oxamyl)phenylboronic acid, 2-dimethylamino-methyl-5-vinylphenyl-boronic acid, 4-(N-allylsulfamoyl)phenylboronic acid, 4-(3-butenyl-sulfonyl)phenylboronic acid, 3-(meth)acrylamido-5-nitrophenylboronic acid, 4-(meth)acrylamido-5-nitrophenylboronic acid, 4-(meth)acrylamido-3-nitrophenylboronic acid, 3-[(meth)acrylamido-C₂-C₅-alkylaminocarbonyl]-5-nitrophenylboronic acid, 3-[(meth)acryloyloxy-C₂-C₅-alkylaminocarbonyl]-5-nitrophenylboronic acid, 3-(meth)acrylamido-6-hydroxymethyl-phenylboronic acid, 3-(meth)acrylamido-6-dimethylaminomethylphenylboronic acid, 4-(meth)acrylamido-6-hydroxymethylphenyl-boronic acid, 4-(meth)acrylamido-6-dimethylamino-methylphenylboronic acid, a reaction production of an amino-containing phenylboronic acid derivative with (meth)acrylic acid halide or an epoxide-containing vinylic monomer or with a carboxy-containing vinylic monomer in the presence of a carbodiimide and N-hydroxysuccinimide, a reaction production of a carboxy-containing phenylboronic acid derivative with an amino-containing vinylic monomer in the presence of a carbodiimide and N-hydroxysuccinimide, or combinations thereof.

11. The coated silicone hydrogel contact lens of embodiment 10, wherein the amino-containing phenylboronic acid derivative is 3-carboxyphenylboronic acid, 4-carboxyphenylboronic acid, 3-boronophenyl-acetic acid, 4-boronophenylacetic acid, 2-(4-boronophenyl)-2-methylpropanoic acid, 3-(4-boronophenyl)propanoic acid, 3-(3-boronophenyl)propanoic acid, 5-(3-boronophenyl)pentanoic acid, 5-(4-boronophenyl)pentanoic acid, 4-(2-carboxyethyl)-3-nitrophenylboronic acid, 3-carboxy-5-nitrophenylboronic acid, 4-carboxy-3-chlorophenylboronic acid, 3-carboxy-4-fluorophenylbornic acid, 3-(3-carboxypropyonyl-amino)phenylboronic acid, or 3-amino-3-(4-boronophenyl)propanoic acid, wherein the carboxy-containing phenylboronic acid derivative is 3-aminophenylboronic acid, 4-aminophenylboronic acid, 4-amino-3-nitrophenylboronic acid, 3-amino-6-hydroxymethyl-phenylboronic acid, 3-amino-6-(dimethylaminomethyl)phenyl-boronic acid, 4-amino-2-hydroxymethylphenylboronic acid, 4-amino-2-(dimethylaminomethyl)-phenylboronic acid, 3-amino-4-fluorophenylboronic acid, 4-(aminomethyl)-5-nitrophenylboronic acid, 3-(aminomethyl)-phenylboronic acid, 3-amino-5-nitrophenylboronic acid, or 3-amino-3-(4-boronophenyl)propanoic acid.

12. The coated silicone hydrogel contact lens of any one of embodiments 1 to 11, wherein the crosslinked polymeric material comprises: (1) poly(ethylene glycol) chains which are designated as PEG chains, (2) polymer chains derived from a copolymer which is a polymerization product of a composition comprising (i) 60% by weight or less of at least one reactive vinylic monomer which comprises at least one reactive functional group selected from the group consisting of carboxylic acid, primary amino group, secondary amino group, epoxide group, and combinations thereof and (ii) at least one non-reactive vinylic monomer selected from the group consisting of acrylamide, methacrylamide, N,N-dimethylacrylamide, N,N-dimethylmethacrylamide, N-vinylpyrrolidone, N,N-dimethylaminoethylmethacrylate, N,N-dimethylaminoethylacrylate, N,N-dimethylaminopropylmethacrylamide, N,N-dimethylaminopropylacrylamide, glycerol methacrylate, 3-acryloylamino-1-propanol, N-hydroxyethyl acrylamide, N-[tris(hydroxymethyl)methyl]-acrylamide, N-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 2-hydroxyethyl (meth)acrylate, hydroxypropyl (meth)acrylate, a phosphorylcholine-containing vinylic monomer, C₁-C₄-alkoxy poly(ethylene glycol)ethyl (meth)acrylate having a weight average molecular weight of up to 1500 Daltons, C₁-C₄-alkoxy poly(ethylene glycol)ethyl (meth)acrylamide having a weight average molecular weight of up to 1500 Daltons, poly(ethylene glycol)ethyl (meth)acrylate having a weight average molecular weight of up to 1500 Daltons, poly(ethylene glycol)ethyl (meth)acrylamide having a weight average molecular weight of up to 1500 Daltons, N-vinyl formamide, N-vinyl acetamide, N-vinyl isopropylamide, N-vinyl-N-methyl acetamide, allyl alcohol, vinyl alcohol, and combinations thereof; or (3) combinations thereof, wherein said at least one reactive vinylic monomer is selected from the group consisting of amino-C₂-C₄ alkyl (meth)acrylate, C₁-C₃ alkylamino-C₂-C₄ alkyl (meth)acrylate, allylamine, vinylamine, amino-C₂-C₄ alkyl (meth)acrylamide, C₁-C₃ alkylamino-C₂-C₄ alkyl (meth)acrylamide, acrylic acid, C₁-C₄ alkylacrylic acid, (meth)acryloxy-C₂-C₆ alkanoic acid, 2-acrylamidoglycolic acid, (meth)acrylamido-C₂-C₆ alkanoic acid, an epoxide-containing vinylic monomer, and combinations thereof, wherein the epoxide-containing vinylic monomer is selected from the group consisting of glycidyl (meth)acrylamide, hydroxylethyl (meth)acrylamide glycidyl ether, 3-hydroxypropyl (meth)acrylamide glycidyl ether, 4-hydroxybutyl (meth)acrylamide glycidyl ether, glycidyl (meth)acrylate, hydroxylethyl (meth)acrylate glycidyl ether, 3-hydroxypropyl (meth)acrylate glycidyl ether, 4-hydroxybutyl (meth)acrylate glycidyl ether, and combinations thereof.

13. The coated silicone hydrogel contact lens of any one of embodiments 1 to 11, wherein the crosslinked polymeric material comprises polymer chains derived from the copolymer which is the polymerization product of the composition comprising (i) from 0.1% to 30% by weight of at least one reactive vinylic monomer and (ii) at least one non-reactive vinylic monomer selected from the group consisting of acrylamide, methacrylamide, N,N-dimethylacrylamide, N,N-dimethylmethacrylamide, N,N-dimethylaminopropyl methacrylamide, N,N-dimethylaminopropylacrylamide, and combinations thereof, wherein said at least one reactive vinylic monomer is selected from the group consisting of amino-C₂-C₄ alkyl (meth)acrylate, C₁-C₃alkylamino-C₂-C₄ alkyl (meth)acrylate, allylamine, vinylamine, amino-C₂-C₄ alkyl (meth)acrylamide, C₁-C₃ alkylamino-C₂-C₄ alkyl (meth)acrylamide, acrylic acid, C₁-C₄ alkylacrylic acid, (meth)acryloxy-C₂-C₆ alkanoic acid, 2-acrylamidoglycolic acid, (meth)acrylamido-C₂-C₆ alkanoic acid, an epoxide-containing vinylic monomer, and combinations thereof, wherein the epoxide-containing vinylic monomer is selected from the group consisting of glycidyl (meth)acrylamide, hydroxylethyl (meth)acrylamide glycidyl ether, 3-hydroxypropyl (meth)acrylamide glycidyl ether, 4-hydroxybutyl (meth)acrylamide glycidyl ether, glycidyl (meth)acrylate, hydroxylethyl (meth)acrylate glycidyl ether, 3-hydroxypropyl (meth)acrylate glycidyl ether, 4-hydroxybutyl (meth)acrylate glycidyl ether, and combinations thereof.

14. The coated silicone hydrogel contact lens of any one of embodiments 1 to 11, wherein the crosslinked polymeric material comprises polymer chains derived from the copolymer which is the polymerization product of the composition comprising (i) from 0.1% to 30% by weight of at least one reactive vinylic monomer and (ii) at least one non-reactive vinylic monomer selected from the group consisting of N,N-dimethylaminoethylmethacrylate, N,N-dimethylaminoethylacrylate, C₁-C₄-alkoxy polyethylene glycol (meth)acrylate having a weight average molecular weight of up to 1500 Daltons, and combinations thereof, wherein said at least one reactive vinylic monomer is selected from the group consisting of amino-C₂-C₄ alkyl (meth)acrylate, C₁-C₃ alkylamino-C₂-C₄ alkyl (meth)acrylate, allylamine, vinylamine, amino-C₂-C₄ alkyl (meth)acrylamide, C₁-C₃ alkylamino-C₂-C₄ alkyl (meth)acrylamide, acrylic acid, C₁-C₄ alkylacrylic acid, (meth)acryloxy-C₂-C₆ alkanoic acid, 2-acrylamidoglycolic acid, (meth)acrylamido-C₂-C₆ alkanoic acid, an epoxide-containing vinylic monomer, and combinations thereof, wherein the epoxide-containing vinylic monomer is selected from the group consisting of glycidyl (meth)acrylamide, hydroxylethyl (meth)acrylamide glycidyl ether, 3-hydroxypropyl (meth)acrylamide glycidyl ether, 4-hydroxybutyl (meth)acrylamide glycidyl ether, glycidyl (meth)acrylate, hydroxylethyl (meth)acrylate glycidyl ether, 3-hydroxypropyl (meth)acrylate glycidyl ether, 4-hydroxybutyl (meth)acrylate glycidyl ether, and combinations thereof.

15. The coated silicone hydrogel contact lens of any one of embodiments 1 to 11, wherein the crosslinked polymeric material comprises polymer chains derived from the copolymer which is the polymerization product of the composition comprising (i) from 0.1% to 30% by weight of at least one reactive vinylic monomer and (ii) at least one non-reactive vinylic monomer selected from the group consisting of glycerol methacrylate, 3-acryloylamino-1-propanol, N-hydroxyethyl acrylamide, N-[tris(hydroxymethyl)methyl]-acrylamide, 2-hydroxyethyl (meth)acrylate, hydroxypropyl (meth)acrylate, allyl alcohol, vinyl alcohol, and combinations thereof, wherein said at least one reactive vinylic monomer is selected from the group consisting of amino-C₂-C₄ alkyl (meth)acrylate, C₁-C₃ alkylamino-C₂-C₄ alkyl (meth)acrylate, allylamine, vinylamine, amino-C₂-C₄ alkyl (meth)acrylamide, C₁-C₃ alkylamino-C₂-C₄ alkyl (meth)acrylamide, acrylic acid, C₁-C₄ alkylacrylic acid, (meth)acryloxy-C₂-C₆ alkanoic acid, 2-acrylamidoglycolic acid, (meth)acrylamido-C₂-C₆ alkanoic acid, an epoxide-containing vinylic monomer, and combinations thereof, wherein the epoxide-containing vinylic monomer is selected from the group consisting of glycidyl (meth)acrylamide, hydroxylethyl (meth)acrylamide glycidyl ether, 3-hydroxypropyl (meth)acrylamide glycidyl ether, 4-hydroxybutyl (meth)acrylamide glycidyl ether, glycidyl (meth)acrylate, hydroxylethyl (meth)acrylate glycidyl ether, 3-hydroxypropyl (meth)acrylate glycidyl ether, 4-hydroxybutyl (meth)acrylate glycidyl ether, and combinations thereof.

16. The coated silicone hydrogel contact lens of any one of embodiments 1 to 11, wherein the crosslinked polymeric material comprises polymer chains derived from the copolymer which is the polymerization product of the composition comprising (i) from 0.1% to 30% by weight of at least one reactive vinylic monomer and (ii) at least one non-reactive vinylic monomer selected from the group consisting of N-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, N-vinylpyrrolidone, N-vinyl formamide, N-vinyl acetamide, N-vinyl isopropylamide, N-vinyl-N-methyl acetamide, and combinations thereof, wherein said at least one reactive vinylic monomer is selected from the group consisting of amino-C₂-C₄ alkyl (meth)acrylate, C₁-C₃ alkylamino-C₂-C₄ alkyl (meth)acrylate, allylamine, vinylamine, amino-C₂-C₄ alkyl (meth)acrylamide, C₁-C₃ alkylamino-C₂-C₄ alkyl (meth)acrylamide, acrylic acid, C₁-C₄ alkylacrylic acid, (meth)acryloxy-C₂-C₆ alkanoic acid, 2-acrylamidoglycolic acid, (meth)acrylamido-C₂-C₆ alkanoic acid, an epoxide-containing vinylic monomer, and combinations thereof, wherein the epoxide-containing vinylic monomer is selected from the group consisting of glycidyl (meth)acrylamide, hydroxylethyl (meth)acrylamide glycidyl ether, 3-hydroxypropyl (meth)acrylamide glycidyl ether, 4-hydroxybutyl (meth)acrylamide glycidyl ether, glycidyl (meth)acrylate, hydroxylethyl (meth)acrylate glycidyl ether, 3-hydroxypropyl (meth)acrylate glycidyl ether, 4-hydroxybutyl (meth)acrylate glycidyl ether, and combinations thereof.

17. The coated silicone hydrogel contact lens of any one of embodiments 1 to 11, wherein the crosslinked polymeric material comprises polymer chains derived from the copolymer which is the polymerization product of the composition comprising (i) from 0.1% to 30% by weight of at least one reactive vinylic monomer and (ii) at least one phosphorylcholine-containing vinylic monomer, wherein said at least one reactive vinylic monomer is selected from the group consisting of amino-C₂-C₄ alkyl (meth)acrylate, C₁-C₃ alkylamino-C₂-C₄ alkyl (meth)acrylate, allylamine, vinylamine, amino-C₂-C₄ alkyl (meth)acrylamide, C₁-C₃ alkylamino-C₂-C₄ alkyl (meth)acrylamide, acrylic acid, C₁-C₄ alkylacrylic acid, (meth)acryloxy-C₂-C₆ alkanoic acid, 2-acrylamidoglycolic acid, (meth)acrylamido-C₂-C₆ alkanoic acid, an epoxide-containing vinylic monomer, and combinations thereof, wherein the epoxide-containing vinylic monomer is selected from the group consisting of glycidyl (meth)acrylamide, hydroxylethyl (meth)acrylamide glycidyl ether, 3-hydroxypropyl (meth)acrylamide glycidyl ether, 4-hydroxybutyl (meth)acrylamide glycidyl ether, glycidyl (meth)acrylate, hydroxylethyl (meth)acrylate glycidyl ether, 3-hydroxypropyl (meth)acrylate glycidyl ether, 4-hydroxybutyl (meth)acrylate glycidyl ether, and combinations thereof.

18. The coated silicone hydrogel contact lens of embodiment 17, wherein the phosphorylcholine-containing vinylic monomer is (meth)acryloyloxyethyl phosphorylcholine.

19. The coated silicone hydrogel contact lens of any one of embodiments 1 to 11, wherein the crosslinked polymeric material comprises poly(ethylene glycol) chains which are designated as PEG chains and which are derived from at least one member selected from the group consisting of: PEG-NH₂; H₂N-PEG-NH₂; H₂N-PEG-COOH; a multi-arm PEG with one or more amino groups; a PEG dendrimer with one or more amino groups; and combinations thereof.

20. The coated silicone hydrogel contact lens of any one of embodiments 1 to 11, wherein the crosslinked polymeric material comprises poly(ethylene glycol) chains which are designated as PEG chains and which are derived from at least one member selected from the group consisting of: PEG-COOH; HOOC-PEG-COOH; a multi-arm PEG with one or more carboxyl groups; a PEG dendrimer with one or more carboxyl groups; and combinations thereof.

21. The coated silicone hydrogel contact lens of any one of embodiments 1 to 11, wherein the crosslinked polymeric material comprises poly(ethylene glycol) chains which are designated as PEG chains and which are derived from at least one member selected from the group consisting of: PEG-SH; HS-PEG-SH; HOOC-PEG-SH; H₂N-PEG-SH; a multi-arm PEG with one or more thiol groups; a PEG dendrimer with one or more thiol groups; and combinations thereof.

22. The coated silicone hydrogel contact lens of any one of embodiments 1 to 11, wherein the crosslinked polymeric material comprises poly(ethylene glycol) chains which are designated as PEG chains and which are derived from at least one member selected from the group consisting of:

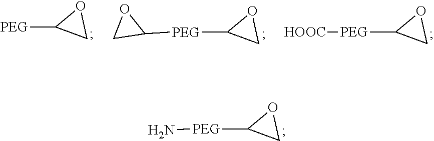

a multi-arm PEG with one or more epoxide groups; a PEG dendrimer with one or more epoxide groups; and combinations thereof.

23. The coated silicone hydrogel contact lens of any one of embodiments 1 to 22, wherein the coated silicone hydrogel contact lens in fully hydrated state has water content of from about 10% to about 70%, an oxygen permeability of from about 50 to 180 barrers, and a water-break-up time of at least 10 seconds.

24. The coated silicone hydrogel contact lens of any one of embodiments 1 to 23, wherein the grafted hydrophilic polymer is derived from said at least one hydrophilic polymer having 1,2- or 1,3-diol moieties.

25. A method for producing coated silicone hydrogel contact lenses, comprising the steps of:
(1) obtaining a preformed silicone hydrogel contact lens, wherein the preformed hydrogel contact lens comprises a bulk silicone hydrogel material that comprises
   (a) repeating units of at least one polysiloxane vinylic crosslinker and/or at least one siloxane-containing vinylic monomer,
   (b) from about 0.5% to about 3.5% by weight of repeating units of at least one carboxyl-containing vinylic monomer,
   (c) repeating units of at least one hydrophilic vinylic monomer,
   (d) from about 2.5% to about 12.5% by weight of repeating units of at least one arylborono-containing vinylic monomer having an arylborono group, and
   (e) optionally but preferably at least one non-silicone vinylic crosslinker; and
(2) heating the preformed silicone hydrogel contact lens in an aqueous coating solution at a temperature from about 60° C. to about 140° C. to form a coated silicone hydrogel contact lens comprising the bulk silicone hydrogel material and a non-silicone hydrogel coating thereon, wherein the aqueous coating solution comprises (a) at least one hydrophilic polymer having 1,2- and/or 1,3-diol moieties and (b) at least one water-soluble, thermally-crosslinkable hydrophilic polymeric material that is branched or slightly-crosslinked and comprises thermally crosslinkable groups and optionally reactive functional groups, wherein the thermally crosslinkable group are azetidinium groups and/or epoxide groups, wherein the reactive functional groups are primary amino groups, secondary amino groups, carboxylic acid groups, thiol groups, or combinations thereof, wherein the non-silicone hydrogel coating comprises a crosslinked polymeric material and a grafted hydrophilic polymer, wherein the crosslinked hydrophilic polymeric material is derived from said at least one water-soluble, thermally-crosslinkable hydrophilic polymeric material and is covalently attached to the bulk silicone hydrogel material through first linkages each formed between one carboxylic acid group and one azetidinium or epoxide group, wherein the grafted hydrophilic polymer is derived from said at least one hydrophilic polymer and is covalently attached to the bulk silicone hydrogel material through second linkages each formed between one arylboronoc group and one 1,2- or 1,3-diol moiety.

26. The method of embodiment 25, wherein the step of heating is performed preferably by autoclaving the preformed silicone hydrogel contact lens immersed in the aqueous coating solution in a sealed lens package at a temperature of from about 115° C. to about 125° C. for approximately 20-90 minutes, wherein the aqueous coating solution further comprises one buffering agents for maintaining a pH of from about 6.8 to about 8.5 and one ore more tonicity agents.

27. The method of embodiment 25 or 26, wherein the aqueous solution has a pH of from about 7.0 to about 8.2, wherein the aqueous solution comprises from about 0.01% to about 2% (preferably from about 0.05% to about 1.5%, more preferably from about 0.1% to about 1%, even more preferably from about 0.2% to about 0.5%) by weight of said at least one water-soluble thermally-crosslinkable hydrophilic polymeric material.

28. The method of any one of embodiments 25 to 27, wherein the aqueous solution comprises a mixture of a monobasic dihydrogen phosphate and dibasic monohydrogen phosphate for maintaining the pH of the aqueous solution, wherein the the total concentration of the monobasic dihydrogen phosphate and the dibasic monohydrogen phosphate is at least 30 mM.

29. The coated silicone hydrogel contact lens of embodiment 24 or the method of any one of embodiments 25 to 28, wherein said at least one diol-containing hydrophilic polymer comprises polyvinyl alcohol, poly(ethylene glycol)-graft-poly(vinyl alcohol), a copolymer of vinyl alcohol and a hydrophilic vinylic monomer, a copolymer of glycerol (meth)acrylate with a hydrophilic vinylic monomer, a copolymer of 2,3,4-trihydroxybutyl (meth)acrylate and a hydrophilic vinylic monomer, a copolymer of 2,2-dihydroxypropyl (meth)acrylate and a hydrophilic vinylic monomer, a copolymer of 2,3-dihydroxybutyl (meth)acrylate and a hydrophilic vinylic monomer, a copolymer of glycerin-2 (meth)acrylate and a hydrophilic vinylic monomer, a copolymer of N-2,3-dihydroxypropyl (meth)acrylamide and a hydrophilic vinylic monomer, a copolymer of 3-allyloxy-1,2-propanediol and a hydrophilic vinylic monomer, or combinations thereof.

30. The method of any one of embodiments 25 to 29, wherein the bulk silicone hydrogel material comprises from about 0.7% to about 3.5% by weight of the repeating units of said at least one carboxyl-containing vinylic monomer.

31. The method of any one of embodiments 25 to 29, wherein the bulk silicone hydrogel material comprises from about 0.9% to about 3.0% by weight of the repeating units of said at least one carboxyl-containing vinylic monomer.

32. The method of any one of embodiments 25 to 29, wherein the bulk silicone hydrogel material comprises from about 1.0% to about 2.8% by weight of the repeating units of said at least one carboxyl-containing vinylic monomer.

33. The method of any one of embodiments 25 to 32, wherein said at least one carboxyl-containing vinylic monomer is selected from the group consisting of acrylic acid, C₁-C₄ alkylacrylic acid, (meth)acrylox-C₁-C₆ alkanoic acid, mono-2-[(meth)acryloxy]-ethyl succinate, 2-acrylamidoglycolic acid, (meth)acrylamido-C₁-C₆ alanoic acid, and combinations thereof.

34. The method of any one of embodiments 25 to 33, wherein the bulk silicone hydrogel material comprises from about 2.5% to about 10% by weight of the repeating units of said at least one arylborono-containing vinylic monomer.

35. The method of any one of embodiments 25 to 33, wherein the bulk silicone hydrogel material comprises from about 3.0% to about 8.0% by weight of the repeating units of said at least one arylborono-containing vinylic monomer.

36. The method of any one of embodiments 25 to 33, wherein the bulk silicone hydrogel material comprises from about 3.5% to about 7.0% by weight of the repeating units of said at least one arylborono-containing vinylic monomer.

37. The method of any one of embodiments 25 to 36, wherein said at least one arylborono-containing vinylic monomer is represented by formula (I)

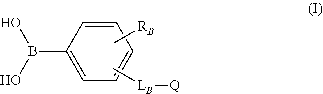

in which: R_{B} is a monovalent radical (preferably is H, NO₂, F, Cl, Br, CF₃, CH₂OH, or CH₂NR^{o}R^{o′}
in which R^{o} and R^{o′} independent of each other are H or C₁-C₄ alkyl); Q is a monovalent radical of

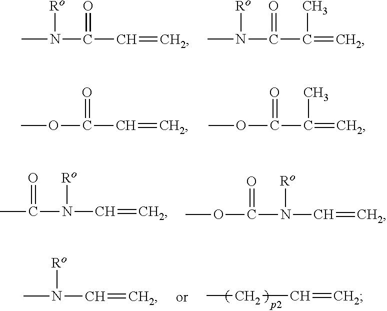

L_{B} is a direct bond, a C₁-C₄ alkylene divalent radical, a divalent radical of

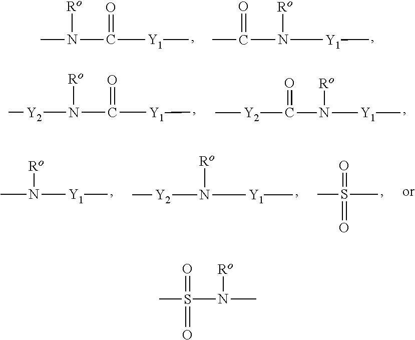

in which Y₁ is CH(OH) or a C₁-C₄ alkylene divalent radical, Y₂ is a C₁-C₄ alkylene divalent radical, p2 is an integer of 0 to 3, and R^{o} is H or a C₁-C₄ alkyl.

38. The method of any one of embodiments 25 to 36, wherein said at least one arylborono-containing vinylic monomer comprises 3-vinylphenylboronic acid, 4-vinylphenylboronic acid, 3-(meth)acrylamidophenylboronic acid, 4-(meth)acrylamidophenylboronic acid, 4-(1,6-dioxo-2,5-diaza-7-oxamyl)phenylboronic acid, 2-dimethylaminomethyl-5-vinylphenyl-boronic acid, 4-(N-allylsulfamoyl)phenylboronic acid, 4-(3-butenylsulfonyl)phenylboronic acid, 3-(meth)acrylamido-5-nitrophenylboronic acid, 4-(meth)acrylamido-5-nitrophenylboronic acid, 4-(meth)acrylamido-3-nitrophenylboronic acid, 3-[(meth)acrylamido-C₂-C₅-alkylaminocarbonyl]-5-nitrophenylboronic acid, 3-[(meth)acryloyloxy-C₂-C₅-alkylaminocarbonyl]-5-nitrophenylboronic acid, 3-(meth)acrylamido-6-hydroxymethyl-phenylboronic acid, 3-(meth)acrylamido-6-dimethylaminomethylphenylboronic acid, 4-(meth)acrylamido-6-hydroxymethylphenylboronic acid, 4-(meth)acrylamido-6-dimethylamino-methylphenylboronic acid, a reaction production of an amino-containing phenylboronic acid derivative with (meth)acrylic acid halide or an epoxide-containing vinylic monomer or with a carboxy-containing vinylic monomer in the presence of a carbodiimide and N-hydroxysuccinimide, a reaction production of a carboxy-containing phenylboronic acid derivative with an amino-containing vinylic monomer in the presence of a carbodiimide and N-hydroxysuccinimide, or combinations thereof.

39. The method of embodiment 38, wherein the amino-containing phenylboronic acid derivative is 3-carboxyphenylboronic acid, 4-carboxyphenylboronic acid, 3-boronophenyl-acetic acid, 4-boronophenylacetic acid, 2-(4-boronophenyl)-2-methylpropanoic acid, 3-(4-boronophenyl)-propanoic acid, 3-(3-boronophenyl)propanoic acid, 5-(3-boronophenyl)pentanoic acid, 5-(4-boronophenyl)pentanoic acid, 4-(2-carboxyethyl)-3-nitrophenylboronic acid, 3-carboxy-5-nitrophenylboronic acid, 4-carboxy-30chlorophenylboronic acid, 3-carboxy-4-fluorophenylbornic acid, 3-(3-carboxypropyonylamino)phenylboronic acid, or 3-amino-3-(4-boronophenyl)propanoic acid, wherein the carboxy-containing phenylboronic acid derivative is 3-aminophenylboronic acid, 4-aminophenylboronic acid, 4-amino-3-nitrophenylboronic acid, 3-amino-6-hydroxymethylphenylboronic acid, 3-amino-6-(dimethylaminomethyl)phenyl-boronic acid, 4-amino-2-hydroxymethylphenylboronic acid, 4-amino-2-(dimethylaminomethyl)-phenylboronic acid, 3-amino-4-fluorophenylboronic acid, 4-(aminomethyl)-5-nitrophenylboronic acid, 3-(aminomethyl)-phenylboronic acid, 3-amino-5-nitrophenylboronic acid, or 3-amino-3-(4-boronophenyl)propanoic acid.

40. The method of any one of embodiments 25 to 39, wherein said at least one water-soluble and thermally crosslinkable hydrophilic polymeric material comprises epoxide groups.

41. The method of embodiment 40, wherein said at least one water-soluble and thermally crosslinkable hydrophilic polymeric material comprises: (i) one or more multi-armed polyethylene glycols each having terminal epoxide groups; (ii) a partial reaction product of a multi-armed polyethylen glycol having terminal epoxide group with one or more polyethylene glycol each having terminal functional groups selected from the group consisting of primary amine groups, secondary amine groups, carboxyl groups, thiol groups, and combinations thereof; (iii) a partial reaction product of a multi-armed polyethylene having terminal epoxide groups with a hydrophilicity-enhancing agent having at least one reactive functional group selected from the group consisting of amino group, carboxyl group, thiol group, and combination thereof; (iv) a partial reaction product of a copolymer of an epoxide-containing vinylic monomer and one or more hydrophilic vinylic monomer with a hydrophilicity-enhancing agent having at least one reactive functional group selected from the group consisting of amino group, carboxyl group, thiol group, and combination thereof; (v) a copolymer of an epoxide-containing vinylicmonomer, a hydrophilic vinylic monomer, and a C₁-C₄-alkoxy poly(ethylene glycol)ethyl (meth)acrylate having a number average molecular weight of up to 2500 Daltons, a poly(ethylene glycol)ethyl (meth)acrylate having a number average molecular weight of up to 2500 Daltons, a C₁-C₄-alkoxy poly(ethylene glycol)ethyl (meth)acrylamide, or a poly(ethylene glycol)ethyl (meth)acrylamide having a number average molecular weight of up to 2500 Daltons); or (vi) combinations thereof.

42. The method of any one of embodiments 25 to 39, wherein said at least one water-soluble and thermally crosslinkable hydrophilic polymeric material comprises azetidinium groups.

43. The method of embodiment 42, wherein said at least one water-soluble and thermally crosslinkable hydrophilic polymeric material is a three-dimensional network and thermally-crosslinkable groups within the network or being attached to the network.

44. The method of embodiment 42, wherein said at least one water-soluble and thermally crosslinkable hydrophilic polymeric material is: one or more multi-armed polyethylene glycols each having terminal epoxide groups; a mixture of a multi-armed polyethylen glycol having terminal epoxide group and one or more polyethylene glycol each having terminal functional groups selected from the group consisting of primary amine groups, secondary amine groups, carboxyl groups, thiol groups, and combinations thereof; a partial reaction product of a multi-armed polyethylene having terminal epoxide groups and a hydrophilicity-enhancing agent having at least one reactive functional group selected from the group consisting of amino group, carboxyl group, thiol group; or combinations thereof.

45. The method of embodiment 42, wherein said at least one water-soluble and thermally crosslinkable hydrophilic polymeric material comprises azetidinium groups and is a partial reaction product of an azetidinium-containing polymer and a hydrophilicity-enhancing agent having at least one reactive functional group selected from the group consisting of a primary amine group, a secondary amine group, a carboxyl group, a thiol group, and combinations thereof.

46. The method of embodiment 45, wherein the azetidinium-containing polymer is a poly(2-oxazoline-co-ethyleneimine)-epichlorohydrin copolymer, a polyamidoamine-epichlorohydrin, a copolymer of an azetidinium-containing vinylic monomer with one or more hydrophilic vinylic monomers, or combinations thereof.

47. The method of embodiment 45 or 46, wherein the hydrophilicity-enhancing agent is: a primary amino-, secondary amino-, carboxyl- or thiol-containing monosaccharide; a primary amino-, secondary amino-, carboxyl- or thiol-containing disaccharide; a primary amino-, secondary amino-, carboxyl- or thiol-containing oligosaccharide; or combinations thereof.

48. The method of embodiment 45 or 46, wherein the hydrophilicity-enhancing agent is a hydrophilic polymer having one or more primary or secondary amino groups, one or more carboxyl groups, one or more thiol groups, or combinations thereof.

49. The method of embodiment 48, wherein the hydrophilicity-enhancing agent is a polysaccharide having primary amine groups, secondary amine groups, carboxyl groups, or combinations thereof.

50. The method of embodiment 48, wherein the hydrophilicity-enhancing agent is:
a poly(ethylene glycol) having one sole functional group of —NH₂, —SH or —COOH; a poly(ethylene glycol) having two terminal functional groups selected from the group consisting of —NH₂, —COOH, —SH, and combinations thereof;
a multi-arm poly(ethylene glycol) having one or more functional groups selected from the group consisting of —NH₂, —COOH, —SH, and combinations thereof;
a monoamino-, monocarboxyl-, diamino- or dicarboxyl-terminated homo- or copolymer of a non-reactive hydrophilic vinylic monomer;
a copolymer which is a polymerization product of a composition comprising (1) from about 0.1% to about 30% (preferably from about 0.5% to about 20%, more preferably from about 1% to about 15%) of a reactive vinylic monomer and and (2) at least one non-reactive hydrophilic vinylic monomer,
wherein said at least one reactive vinylic monomer is a vinylic monomer having a functional group selected from the group consisting of carboxyl group, a primary amine group, and a secondary amine group,
wherein the non-reactive hydrophilic monomer is a hydrophilic vinylic monomer free of any free of any carboxyl group, primary amine group, secondary amine group, epoxide group, isocyanate group, azlactone group, or aziridine group.

51. The method of embodiment 50, wherein the reactive vinylic monomer is amino-C₂-C₄ alkyl (meth)acrylate, C₁-C₃ alkylamino-C₂-C₄ alkyl (meth)acrylate, allylamine, vinylamine, amino-C₂-C₄ alkyl (meth)acrylamide, C₁-C₃ alkylamino-C₂-C₄ alkyl (meth)acrylamide, acrylic acid, C₁-C₄ alkylacrylic acid, (meth)acryloxy-C₂-C₆ alkanoic acid, 2-acrylamidoglycolic acid, (meth)acrylamido-C₂-C₆ alkanoic acid, and combinations thereof.

52. The method of embodiments 50 or 51, wherein the non reactive hydrophilic vinylic monomer is selected from the group consisting of (meth)acryloyloxyethyl phosphorylcholine, (meth)acryloyloxypropyl phosphorylcholine, 4-((meth)acryloyloxy)butyl-2′-(trimethylammonio)-ethylphosphate, 2-[(meth)acryloylamino]ethyl-2′(trimethylammonio)ethylphosphate, 3-[(meth)acryloylamino]propyl-2′-(trimethylammonio)ethylphosphate, 4-[(meth)acryloylamino]butyl-2′-(trimethylammonio)ethyl-phosphate, (meth)acrylamide, dimethyl (meth)acrylamide, N-2-hydroxylethyl (meth)acrylamide, N,N-bis(hydroxyethyl) (meth)acrylamide, N-2,3-dihydroxypropyl (meth)acrylamide, N-tris(hydroxymethyl)methyl (meth)acrylamide, 2-hydroxyethyl (meth)acrylate, glycerol methacrylate (GMA), tetra(ethylene glycol) (meth)acrylate, poly(ethylene glycol)ethyl (meth)acrylamide having a number average molecular weight of up to 1500, poly(ethylene glycol) (meth)acrylate having a number average molecular weight of up to 1500, N-vinylpyrrolidone, N-vinyl-N-methyl acetamide, N-vinyl formamide, N-vinyl acetamide, 1-methyl-3-methylene-2-pyrrolidone, 1-methyl-5-methylene-2-pyrrolidone, 5-methyl-3-methylene-2-pyrrolidone, tetra(ethylene glycol) methyl ether (meth)acrylate, methoxypoly(ethylene glycol)ethyl (meth)acrylamide having a number average molecular weight of up to 1500, C₁-C₄-alkoxy polyethylene glycol (meth)acrylate having a weight average molecular weight of up to 1500, tetra(ethylene glycol) monovinyl ether, poly(ethylene glycol) monovinyl ether, tetra(ethylene glycol) methyl vinyl ether, poly(ethylene glycol) methyl vinyl ether, tetra(ethylene glycol) monoallyl ether, poly(ethylene glycol) monoallyl ether, tetra(ethylene glycol) methyl allyl ether, poly(ethylene glycol) methyl allyl ether, vinyl alcohol, allyl alcohol, and combinations thereof.

The previous disclosure will enable one having ordinary skill in the art to practice the invention. Various modifications, variations, and combinations can be made to the various embodiment described herein. In order to better enable the reader to understand specific embodiments and the advantages thereof, reference to the following examples is suggested. It is intended that the specification and examples be considered as exemplary.

### Example 1

### Oxygen Permeability Measurements

Unless specified, the oxygen transmissibility (Dk/t), the intrinsic (or edge-corrected) oxygen permeability (Dkᵢ or Dk_{c}) of a lens and a lens material are determined according to procedures described in ISO 18369-4.

### Water Break-Up Time (WBUT) Tests

The surface hydrophilicity of lenses is assessed by determining the time required for the water film to start breaking on the lens surface using the interfacial dewetting and drainage optical platform (iDDroP) as described by Bhamla et al. in their article entitled Influence of Lipid Coatings on Surface Wettability Characteristics of Silicone Hydrogels published in Langmuir. 2015, 31:3820-3828. During the IDDrop test, the lens is placed on a stage and submerged in PBS. Then, a small surface of the lens is exposed to air. A motorized linear stage and motion controller are used in order to expose the contact lens at specified depths. Video of the water break-up is captured in order to evaluate water break-up time as well as the pattern in which the water film breaks up.

### Equilibrium Water Content

The equilibrium water content (EWC) of contact lenses (i.e., water content of a contact lens in fully hydrated state) are determined according to the procedures described in Example 1 of U.S. Pat. Appl. Pub. No. 20210181379 A1.

### Elastic Modulus

The elastic modulus of a contact lens is determined according to the procedures described in Example 1 of U.S. Pat. Appl. Pub. No. 20210181379 A1.

Water Contact Angle (WCA) Measurements. Water contact angle (WCA) measurements are performed by the sessile drop method with a DSA 10 drop shape analysis system from Kruss GmbH, Germany with pure water (Fluka, surface tension 72.5 mN/m at 20° C.). For measurement purposes a contact lens is taken off the storage solution with tweezers and excess storage solution is removed by gentle shaking. The contact lens are placed on the male part of a lens mold and gently blotted with a dry and clean cloth. A water droplet (approximately 1 μl) is then dosed on the lens apex, and the change of the contact angle over time of this water droplet (WCA(t), circle fitting mode) is monitored. The WCA is calculated by the extrapolation of the graph WCA(t) to t=0.

### Lubricity Evaluation.

The lubricity of a contact lens is evaluated by using a finger-felt lubricity test which characterizes qualitatively the slipperiness of a lens surface on a friction rating scale of from 0 to 4. The higher the friction rating is, the lower the slipperiness (or lubricity). During this test, a lens is felt between the thumb and forefinger, and is qualitatively given a rating from 0-4 based on the perceived levels of friction by a tester. The rating given is in comparison to 5 commercial lenses that serve as standards for this test, corresponding to the 5 levels of lubricity.

The levels and standards are as follows: the DAILIES® TOTAL1® lens (Alcon) is a standard for a 0 rating on the scale, the ACUVUE® OASYS™ lens (Johnson & Johnson) is a standard rating of 1, the ULTRA® lens (Bausch & Lamb) is a standard rating of 2, the DAILIES® Aqua Comfort Plus® lens (Alcon) is a standard rating of 3, and the AIR OPTIX® Aqua lens is a standard rating of 4.

The samples are placed in PBS for at least two rinses of 30 minutes each and then transferred to fresh PBS before the evaluation. Before the evaluation, hands are rinsed with a soap solution, extensively rinsed with DI water and then dried with KimWipe® towels. When evaluating the lubricity of the anterior surface, the lens is placed on a forefinger with its posterior surface facing the forefinger and the thumb moves against the anterior surface to feel the slipperiness (or lubricity) of the anterior surface. When evaluating the the lubricity of the posterior surface, the lens is first inverted and then placed on a forefinger with the inverted anterior surface facing the forefinger, and then the thumb moves against the inverted posterior surface to feel the slipperiness (or lubricity) of the posterior surface.

Each samples are assigned a friction rating relative to the above standard lenses described above. The value of a friction rating is one obtained by averaging the results of at least two friction ratings of a contact lens by two or more persons and/or by averaging the friction ratings of two or more contact lenses (from the identical batch of lens production) by one person.

The finger lubricities (i.e., friction ratings) of a contact lens can be determined directly out-of-pack (OOP) but after >30 min soaking in PBS according to the procedures described above.

### Coating Intactness Tests

The intactness of a coating on the surface of a coated SiHy contact lens can be tested according to Sudan Black stain test as follow. SiHy contact lenses each with a coating thereon are dipped into a Sudan Black dye solution (Sudan Black in the mixture ˜80% mineral oil and ˜20% vitamin E oil). Sudan Black dye is hydrophobic and has a great tendency to be adsorbed by a hydrophobic material or onto a hydrophobic lens surface or hydrophobic spots on a partially coated surface of a hydrophobic lens (e.g., silicone hydrogel contact lens). If the coating on a hydrophobic lens is intact, no staining spots should be observed on or in the lens. All of the lenses under test are fully hydrated. Visible fine lines on lens surface may indicate the presence of cracking of the crosslinked coatings.

The image of the Sudan Black stained contact lens is recorded by a digital camera and then analyzed with a computer to determine the percentage SBQ (%, OOP) of stained areas on the coated SiHy contact lens (“SBQ”) that is taken directly out of package (“OOP”) or out of package and subjected to an aqueous extraction process (“2×cycling”) consisting of: (1) 1^{st} cycle of simulated 1-day-wearing extraction which involves taking out and blotting one readily-usable SiHy contact lenses from a sealed package, and soaking the blotted readily-usable SiHy contact lenses in 1.0 mL of fresh phosphate buffered saline (PBS) (which has a pH of 7.2±0.2 at 25° C. and contains about 0.077 wt. % NaH₂PO₄·H₂O, about 0.31 wt. % Na₂HPO₄·2H₂O, and about 0.77 wt. % NaCl) as extraction medium in one vial for 24 hours at 35° C. with agitation; and (2) 2^{nd} to 7^{th} cycles of simulated 1-day-wearing extraction each of which involves pipeting out all the PBS used in the preceeding cycle, then adding 1.0 mL of fresh PBS as extraction medium into the vial, and soaking the readily-usable SiHy contact lenses in the added 1 mL of the fresh PBS as extraction medium for 24 hours at 35° C. with agitation. The coating intactness is (1-SBQ) when determined directly out of package.

As controls, SiHy contact lenses without any coating are also tested. Because these SiHy contact lenses in the control experiments are free of a hydrogel coating thereon, their surfaces are completely stained by Sudan Black.

### Chemicals

The following abbreviations are used in the following examples: HEMA represents hydroxyethyl methacrylate; EOEMA represents ethoxyethyl methacrylate; MAA represents methacrylic acid; NaMAA represent sodium salt of methacrylic acid; AA represents acrylic acid; TEGDMA is tri(ethylene glycol) dimethacrylate; APBA represents 3-acrylamidophenylboronic acid (pKa ˜8.2); VPBA represents 4-vinylphenylboronic acid (pKa ˜8.8); Vazo 67 represents 2,2′-azodi(2-methyl-butyronitrile); Nobloc is 2-[3-(2H-Benzotriazol-2-yl)-5-hydroxyphenyl]ethyl methacrylate; RB247 is Reactive Blue 247; PBS represents a phosphate-buffered saline which has a pH of 7.2±0.2 at 25° C. and contains about 0.044 wt. % NaH₂PO₄—H₂O, about 0.388 wt. % Na₂HPO₄-2H₂O, and about 0.79 wt. % NaCl and; wt. % represents weight percent; PG represetns propylene glycol; EDTA represents ethylenediaminetetraacetic acid; poly(AAm-co-AA) represents poly(AAm-co-AA)(90/10) partial sodium salt (Mw ˜200,000, from Polysciences, Inc.); PAE represents polyamidoamine-epichlorohydrin; “PEG-PDMS” macromer represents a di-methacryloyloxypropyl-terminated polysiloxane (Mn ˜13K g/mol, x ˜85, y ˜8, z ˜12) of formula (A).

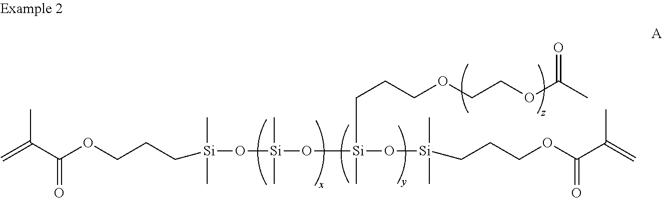

### Phosphate Buffered Saline (PBS)

A phosphate buffered saline is prepared by dissolving NaH₂PO₄·H₂O, Na₂HPO₄·2H₂O, and NaCl in a given volume of purified water (distilled or deionized) to have the following composition: ca. 0.044 w/w % NaH₂PO₄·H₂O, ca. 0.388 w/w/% Na₂HPO₄·2H₂0, and ca. 0.79 w/w % NaCl.

### Preparation of In-Package-Coating Salines

Kymene or PAE solutons of different solid contents is purchased from Solenis as an aqueous solution and used as received.

Polyvinyl alcohol (PVA) (Mw ˜80,000 Daltons) is purchased from Sigma Aldrich and used as received.

Poly(ethylene glycol)-graft-poly(vinyl alcohol) polymer (“PEG-PVA”) (Mw 45,000 Daltons) is purchased from BASF and used as received.

Poly (N-vinylpyrrolidone-co-vinyl alcohol) copolymer (“PVP-PVA”) is prepared by hydrolysis from Poly (N-vinylpyrrolidone-co-vinyl acetate) copolymer (“PVP-PVAc”) (Mw 50,000 Daltons) purchased from Sigma Aldrich.

IPC saline (IPC-1) is prepared by dissolving: about 0.07% by weight of poly(AAm-co-AA); about 0.05% by weight of PAE; 0.776% by weight of Na₂HPO₄·2H₂O; 0.044% by weight of NaH₂PO₄—H₂O; 0.160% by weight of NaCl; and 10 ppm of EDTA in water.

IPC saline (IPC-2) is prepared by dissolving: about 0.07% by weight of poly(AAm-co-AA); about 0.05% by weight of PAE; about 0.2% by weight of PVA; 0.776% by weight of Na₂HPO₄·2H₂O; 0.044% by weight of NaH₂PO₄—H₂O; 0.160% by weight of NaCl; and 10 ppm of EDTA in water.

IPC saline (IPC-3) is prepared by dissolving: about 0.07% by weight of poly(AAm-co-AA); about 0.05% by weight of PAE; about 0.05% by weight of PVA; 0.776% by weight of Na₂HPO₄·2H₂O; 0.044% by weight of NaH₂PO₄—H₂O; 0.160% by weight of NaCl; and 10 ppm of EDTA in water.

IPC saline (IPC-4) is prepared by dissolving: about 0.07% by weight of poly(AAm-co-AA); about 0.05% by weight of PAE; about 0.1% by weight of PEG-PVA; 0.776% by weight of Na₂HPO₄·2H₂O; 0.044% by weight of NaH₂PO₄—H₂O; 0.160% by weight of NaCl; and 10 ppm of EDTA in water.

IPC saline (IPC-5) is prepared by dissolving: about 0.07% by weight of poly(AAm-co-AA); about 0.05% by weight of PAE; about 0.1% by weight of PVP-PVA; 0.776% by weight of Na₂HPO₄·2H₂O; 0.044% by weight of NaH₂PO₄—H₂O; 0.160% by weight of NaCl; and 10 ppm of EDTA in water.

Preparation of Polymerizable Compositions Polymerizable compositions (i.e., SiHy lens formulations) are prepared by adding all the components in their targeted amounts into a clean bottle, with a stir bar to mix at 600 rpm for 30 minutes at room temperature. After all the solid is dissolved, a filtration of the formulation is carried out by using 2.7 pm glass-microfiber-filter (GMF). Eight SiHy lens formulations are prepared to have the compositions reported in Table 1.

TABLE 1

| | SiHy Lens formulation No. (weight unit parts) | | | | | | | |
|---|---|---|---|---|---|---|---|---|
| | SiHy-1 | SiHy-2 | SiHy-3 | SiHy-4 | SiHy-5 | SiHy-6 | SiHy-7 | SiHy-8 |
| EOEMA | 45 | 45 | 45 | 45 | 45 | 45 | 45 | 45 |
| PEG-PDMS | 40 | 40 | 40 | 40 | 40 | 40 | 40 | 40 |
| HEMA | 0 | 0 | 2 | 2 | 2 | 2 | 2 | 2 |
| VPBA | 10 | 0 | 5 | 0 | 5 | 0 | 5 | 0 |
| APBA | 0 | 10 | 0 | 5 | 0 | 5 | 0 | 5 |
| AA | 3 | 3 | 0 | 0 | 0 | 0 | 0 | 0 |
| MAA | 0 | 0 | 1.5 | 1.5 | 1.0 | 1.0 | 1.0 | 1.0 |
| NaMAA | 0 | 0 | 1.5 | 1.5 | 1.5 | 1.5 | 1.0 | 1.0 |
| TEGDMA | 0.5 | 0.5 | 0.3 | 0.3 | 0.3 | 0.3 | 0.3 | 0.3 |
| Vazo 67 | 0.5 | 0.5 | 0.5 | 0.5 | 0.5 | 0.5 | 0.5 | 0.5 |
| Norbloc | 1.5 | 1.5 | 1.5 | 1.5 | 1.5 | 1.5 | 1.5 | 1.5 |
| RB247 | 0.01 | 0.01 | 0.01 | 0.01 | 0.01 | 0.01 | 0.01 | 0.01 |
| PG | 10 | 10 | 10 | 10 | 10 | 10 | 10 | 10 |

Preparation of Coated SiHy Contact lenses

A lens formulation prepared above is purged with nitrogen at room temperature for 30 to 35 minutes. The N2-purged lens formulation is introduced into polypropylene molds and thermally cured in an oven under nitrogen under the following curing conditions: ramp from room temperature to 55° C. at a ramp rate of about 7° C./minute; holding at 55° C. for about 30 minutes; ramp from 55° C. to 100° C. at a ramp rate of about 7° C./minute; holding at 100° C. for about 60 minutes. The molds are opened, and the molded lenses are removed from the molds.

The lenses are then hydrated in an IPC saline prepared above for >120 minutes, inspected, and packaged in blisters in the IPC saline for sterilization (autoclaved at 121° C. for 45 minutes).

### Example 3

Coated SiHy contact lenses are prepared according to the procedures described in Example 2. The two SiHy lens formulations (SiHy-1 and SiHy-2) prepared in Example 2 and the two IPC salines (IPC-1 and IPC-2) prepared in Example 2 are used in this example.

Table 2 shows the characterization results of the coated SiHy contact lenses which comprises a bulk silicone hydrogel material obtained from SiHy-1 lens formulation or SiHy-2 lens formulation and a non-silicone hydrogel coating derived from IPC-1 saline (as control) or IPC-2 saline.

TABLE 2

| SiHy lens formulation | SiHy-1 | SiHy-1 | SiHy-2 | SiHy-2 |
|---|---|---|---|---|
| IPC saline | IPC-1 | IPC-2 | IPC-1 | IPC-2 |
| SBQ (%, OOP) | 18.1 | 0.05 | 48.4 | 0.12 |
| Friction Rating (OOP) | 0-1 | 0-1 | NA | 3 |
| Friction Rating (2 × cycling) | 0-1 | 3-4 | NA | NA |

It can be noticed that when the IPC saline contains a hydrophilic polymer having 1,2- or 1,3-diol moieties (i.e., PVA), the intactness of the coating is improved (IPC-2 vs IPC-1). This indicates the formation of a non-silicone hydrogel coating (“hybrid coating”) on a preformed SiHy contact lens. The non-silicone hydrogel coating is covalently attached to the bulk SiHy material and consists of a crosslinked polymeric material and a PVA distributed therein.

### Example 4

Coated SiHy contact lenses are prepared according to the procedures described in Example 2. The two SiHy lens formulations (SiHy-3 and SiHy-4) prepared in Example 2 and the four IPC salines (IPC-1, IPC-3, IPC-4, and IPC-5) prepared in Example 2 are used in this example.

Table 3 shows the characterization results of the coated SiHy contact lenses which comprises a bulk silicone hydrogel material obtained from SiHy-3 lens formulation and a non-silicone hydrogel coating derived from IPC-1 saline (as control), IPC-3, IPC-4, or IPC-5 saline.

TABLE 3

| SiHy lens formulation | SiHy-3 | SiHy-3 | SiHy-3 | SiHy-3 |
|---|---|---|---|---|
| IPC saline | IPC-1 | IPC-3 | IPC-4 | IPC-5 |
| SBQ (%, OOP) | 23.72 | 0.61 | 0.02 | 0.22 |
| Friction Rating (OOP) | 0 | 0-1 | 0 | 0 |
| Friction Rating (2 × cycling) | 0 | 0 | 0 | 0 |

Table 4 shows the characterization results of the coated SiHy contact lenses which comprises a bulk silicone hydrogel material obtained from SiHy-3 lens formulation and a non-silicone hydrogel coating derived from IPC-1 saline (as control), IPC-3, IPC-4, or IPC-5 saline.

TABLE 4

| SiHy lens formulation | SiHy-4 | SiHy-4 | SiHy-4 | SiHy-4 |
|---|---|---|---|---|
| IPC saline | IPC-1 | IPC-3 | IPC-4 | IPC-5 |
| SBQ (%, OOP) | 48.43 | 0.05 | 6.61 | 17.47 |
| Friction Rating (OOP) | 0 | 0-1 | 2 | 0-1 |
| Friction Rating (2 × cycling) | 0-1 | 3 | 4 | 1-2 |

It can be noticed that when the IPC salie contains a hydrophilic polymer having 1,2- or 1,3-diol moieties (i.e., PVA, PEG-PVA or PVP-PVA), the intacness of the coating is improved (compared to IPC-1). This indicates the formation of a non-silicone hydrogel coating (“hybrid coating”) on a preformed SiHy contact lens. The non-silicone hydrogel coating is covalently attached to the bulk SiHy material and consists of a crosslinked polymeric material and a PVA distributed therein.

### Example 5

Coated SiHy contact lenses are prepared according to the procedures described in Example 2. The two SiHy lens formulations (SiHy-5 and SiHy-6) prepared in Example 2 and the two IPC salines (IPC-1 and IPC-3) prepared in Example 2 are used in this example.

Table 5 shows the characterization results of the coated SiHy contact lenses which comprises a bulk silicone hydrogel material obtained from SiHy-5 or SiHy-6 lens formulation and a non-silicone hydrogel coating derived from IPC-1 saline (as control) or IPC-3 saline.

TABLE 5

| SiHy lens formulation | SiHy-5 | SiHy-5 | SiHy-6 | SiHy-6 |
|---|---|---|---|---|
| IPC saline | IPC-1 | IPC-3 | IPC-1 | IPC-3 |
| SBQ (%, OOP) | 49.49 | 0.03 | 82.39 | 0.22 |
| Friction Rating (OOP) | 0-1 | 1 | 0-1 | 4 |
| Friction Rating (2 × cycling) | 0-1 | 1-2 | 0-1 | 3-4 |

It can be noticed that when the IPC saline contains a hydrophilic polymer having 1,2- or 1,3-diol moieties (i.e., PVA), the intactness of the coating is improved (IPC-3 vs IPC-1). This indicates the formation of a non-silicone hydrogel coating (“hybrid coating”) on a preformed SiHy contact lens. The non-silicone hydrogel coating is covalently attached to the bulk SiHy material and consists of a crosslinked polymeric material and a PVA distributed therein.

### Example 6

Coated SiHy contact lenses are prepared according to the procedures described in Example 2. The two SiHy lens formulations (SiHy-7 and SiHy-8) prepared in Example 2 and the two IPC salines (IPC-1 and IPC-3) prepared in Example 2 are used in this example.

Table 6 shows the characterization results of the coated SiHy contact lenses which comprises a bulk silicone hydrogel material obtained from SiHy-7 or SiHy-8 lens formulation and a non-silicone hydrogel coating derived from IPC-1 saline (as control) or IPC-3 saline.

TABLE 6

| SiHy lens formulation | SiHy-7 | SiHy-7 | SiHy-8 | SiHy-8 |
|---|---|---|---|---|
| IPC saline | IPC-1 | IPC-3 | IPC-1 | IPC-3 |
| SBQ (%, OOP) | 96.50 | 1.11 | 98.49 | 0.09 |
| Friction Rating (OOP) | 3 | 4 | 1-2 | 3 |
| Friction Rating (2 × cycling) | 4 | 4 | 1-2 | 3 |

It can be noticed that when the IPC saline contains a hydrophilic polymer having 1,2- or 1,3-diol moieties (i.e., PVA), the intactness of the coating is improved (IPC-3 vs IPC-1). This indicates the formation of a non-silicone hydrogel coating (“hybrid coating”) on a preformed SiHy contact lens. The non-silicone hydrogel coating is covalently attached to the bulk SiHy material and consists of a crosslinked polymeric material and a PVA distributed therein.

All the publications, patents, and patent application publications, which have been cited herein above in this application, are hereby incorporated by reference in their entireties.

What is claimed is:

1. A coated silicone hydrogel contact lens comprising:
a bulk silicone hydrogel material and a non-silicone hydrogel coating thereon,
wherein the bulk silicone hydrogel material comprises (a) repeating units of at least one polysiloxane vinylic crosslinker and/or at least one siloxane-containing vinylic monomer, (b) repeating units of at least one carboxyl-containing vinylic monomer relative to the total amount of all polymerizable components, (c) repeating units of at least one hydrophilic vinylic monomer, (d) repeating units of at least one arylborono-containing vinylic monomer having an arylborono group, and (e) optionally but preferably repeating units of at least one non-silicone vinylic crosslinker,
wherein the non-silicone hydrogel coating comprises a crosslinked polymeric material and a grafted hydrophilic polymer that is distributed in but not covalently bonded to the crosslinked polymeric material, wherein the crosslinked hydrophilic polymeric material is covalently attached to the bulk silicone hydrogel material through first linkages each formed between one carboxylic acid group and one azetidinium or epoxide group, wherein the grafted hydrophilic polymer comprises 1,2- and/or 1,3-diol moieties and is covalently attached to the bulk silicone hydrogel material through second linkages each formed between one arylboronoc group and one 1,2- or 1,3-diol moiety,
wherein the coated silicone hydrogel contact lens in fully hydrated state exhibits a coating intactness of about 90% or higher and a friction rating of about 2.0 or lower.

2. The coated silicone hydrogel contact lens of claim 1, wherein said at least one carboxyl-containing vinylic monomer is selected from the group consisting of acrylic acid, C₁-C₄ alkylacrylic acid, (meth)acrylox-C₁-C₆ alkanoic acid, mono-2-[(meth)acryloxy]-ethyl succinate, 2-acrylamidoglycolic acid, (meth)acrylamido-C₁-C₆ alanoic acid, and combinations thereof.

3. The coated silicone hydrogel contact lens of claim 2, wherein said at least one arylborono-containing vinylic monomer is represented by formula (I) 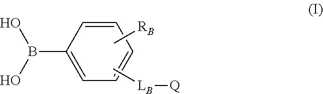
in which: R_{B} is H, NO₂, F, Cl, Br, CF₃, CH₂OH, or CH₂NR^{o}R^{o′} in which R^{o} and R^{o′} independent of each other are H or C₁-C₄ alkyl; Q is a monovalent radical of N 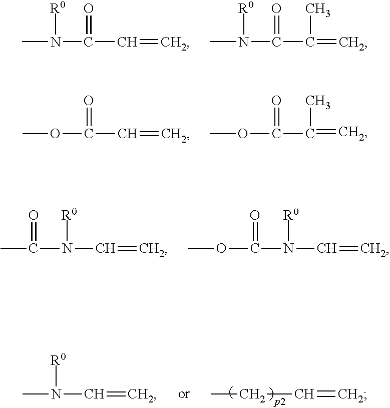
L_{B} is a direct bond, a C₁-C₄ alkylene divalent radical, a divalent radical of 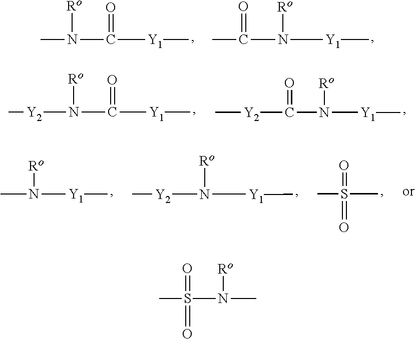
in which Y₁ is CH(OH) or a C₁-C₄ alkylene divalent radical, Y₂ is a C₁-C₄ alkylene divalent radical, p2 is an integer of 0 to 3, and R^{o} is H or a C₁-C₄ alkyl.

4. The coated silicone hydrogel contact lens of claim 3, wherein said at least one arylborono-containing vinylic monomer comprises 3-vinylphenylboronic acid, 4-vinylphenylboronic acid, 3-(meth)acrylamidophenylboronic acid, 4-(meth)acrylamido-phenylboronic acid, 4-(1,6-dioxo-2,5-diaza-7-oxamyl)phenylboronic acid, 2-dimethylamino-methyl-5-vinylphenyl-boronic acid, 4-(N-allylsulfamoyl)phenylboronic acid, 4-(3-butenyl-sulfonyl)phenylboronic acid, 3-(meth)acrylamido-5-nitrophenylboronic acid, 4-(meth)acrylamido-5-nitrophenylboronic acid, 4-(meth)acrylamido-3-nitrophenylboronic acid, 3-[(meth)acrylamido-C₂-C₅-alkylaminocarbonyl]-5-nitrophenylboronic acid, 3-[(meth)acryloyloxy-C₂-C₅-alkylaminocarbonyl]-5-nitrophenylboronic acid, 3-(meth)acrylamido-6-hydroxymethyl-phenylboronic acid, 3-(meth)acrylamido-6-dimethylaminomethylphenylboronic acid, 4-(meth)acrylamido-6-hydroxymethylphenyl-boronic acid, 4-(meth)acrylamido-6-dimethylamino-methylphenylboronic acid, a reaction production of an amino-containing phenylboronic acid derivative with (meth)acrylic acid halide or an epoxide-containing vinylic monomer or with a carboxy-containing vinylic monomer in the presence of a carbodiimide and N-hydroxysuccinimide, a reaction production of a carboxy-containing phenylboronic acid derivative with an amino-containing vinylic monomer in the presence of a carbodiimide and N-hydroxysuccinimide, or combinations thereof.

5. The coated silicone hydrogel contact lens of claim 4, wherein the amino-containing phenylboronic acid derivative is 3-carboxyphenylboronic acid, 4-carboxyphenylboronic acid, 3-boronophenyl-acetic acid, 4-boronophenylacetic acid, 2-(4-boronophenyl)-2-methylpropanoic acid, 3-(4-boronophenyl)propanoic acid, 3-(3-boronophenyl)propanoic acid, 5-(3-boronophenyl)pentanoic acid, 5-(4-boronophenyl)pentanoic acid, 4-(2-carboxyethyl)-3-nitrophenylboronic acid, 3-carboxy-5-nitrophenylboronic acid, 4-carboxy-3-chlorophenylboronic acid, 3-carboxy-4-fluorophenylbornic acid, 3-(3-carboxypropyonyl-amino)phenylboronic acid, or 3-amino-3-(4-boronophenyl)propanoic acid, wherein the carboxy-containing phenylboronic acid derivative is 3-aminophenylboronic acid, 4-aminophenylboronic acid, 4-amino-3-nitrophenylboronic acid, 3-amino-6-hydroxymethyl-phenylboronic acid, 3-amino-6-(dimethylaminomethyl)phenyl-boronic acid, 4-amino-2-hydroxymethylphenylboronic acid, 4-amino-2-(dimethylaminomethyl)-phenylboronic acid, 3-amino-4-fluorophenylboronic acid, 4-(aminomethyl)-5-nitrophenylboronic acid, 3-(aminomethyl)-phenylboronic acid, 3-amino-5-nitrophenylboronic acid, or 3-amino-3-(4-boronophenyl)propanoic acid.

6. The coated silicone hydrogel contact lens of claim 3, wherein the crosslinked polymeric material comprises: (1) poly(ethylene glycol) chains which are designated as PEG chains, (2) polymer chains derived from a copolymer which is a polymerization product of a composition comprising (i) 60% by weight or less of at least one reactive vinylic monomer which comprises at least one reactive functional group selected from the group consisting of carboxylic acid, primary amino group, secondary amino group, epoxide group, and combinations thereof and (ii) at least one non-reactive vinylic monomer selected from the group consisting of acrylamide, methacrylamide, N,N-dimethylacrylamide, N,N-dimethylmethacrylamide, N-vinylpyrrolidone, N,N-dimethylaminoethylmethacrylate, N,N-dimethylaminoethylacrylate, N,N-dimethylaminopropylmethacrylamide, N,N-dimethylaminopropylacrylamide, glycerol methacrylate, 3-acryloylamino-1-propanol, N-hydroxyethyl acrylamide, N-[tris(hydroxymethyl)methyl]-acrylamide, N-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 2-hydroxyethyl (meth)acrylate, hydroxypropyl (meth)acrylate, a phosphorylcholine-containing vinylic monomer, C₁-C₄-alkoxy poly(ethylene glycol)ethyl (meth)acrylate having a weight average molecular weight of up to 1500 Daltons, C₁-C₄-alkoxy poly(ethylene glycol)ethyl (meth)acrylamide having a weight average molecular weight of up to 1500 Daltons, poly(ethylene glycol)ethyl (meth)acrylate having a weight average molecular weight of up to 1500 Daltons, poly(ethylene glycol)ethyl (meth)acrylamide having a weight average molecular weight of up to 1500 Daltons, N-vinyl formamide, N-vinyl acetamide, N-vinyl isopropylamide, N-vinyl-N-methyl acetamide, allyl alcohol, vinyl alcohol, and combinations thereof; or (3) combinations thereof, wherein said at least one reactive vinylic monomer is selected from the group consisting of amino-C₂-C₄ alkyl (meth)acrylate, C₁-C₃ alkylamino-C₂-C₄ alkyl (meth)acrylate, allylamine, vinylamine, amino-C₂-C₄ alkyl (meth)acrylamide, C₁-C₃ alkylamino-C₂-C₄ alkyl (meth)acrylamide, acrylic acid, C₁-C₄ alkylacrylic acid, (meth)acryloxy-C₂-C₆ alkanoic acid, 2-acrylamidoglycolic acid, (meth)acrylamido-C₂-C₆ alkanoic acid, an epoxide-containing vinylic monomer, and combinations thereof, wherein the epoxide-containing vinylic monomer is selected from the group consisting of glycidyl (meth)acrylamide, hydroxylethyl (meth)acrylamide glycidyl ether, 3-hydroxypropyl (meth)acrylamide glycidyl ether, 4-hydroxybutyl (meth)acrylamide glycidyl ether, glycidyl (meth)acrylate, hydroxylethyl (meth)acrylate glycidyl ether, 3-hydroxypropyl (meth)acrylate glycidyl ether, 4-hydroxybutyl (meth)acrylate glycidyl ether, and combinations thereof.

7. The coated silicone hydrogel contact lens of claim 6, wherein the coated silicone hydrogel contact lens in fully hydrated state has water content of from about 10% to about 70%, an oxygen permeability of from about 50 to 180 barrers, and a water-break-up time of at least 10 seconds.

8. The coated silicone hydrogel contact lens of claim 7, wherein the grafted hydrophilic polymer is derived from said at least one hydrophilic polymer having 1,2- or 1,3-diol moieties.

9. The coated silicone hydrogel contact lens of claim 8, wherein said at least one diol-containing hydrophilic polymer comprises polyvinyl alcohol, poly(ethylene glycol)-graft-poly(vinyl alcohol), a copolymer of vinyl alcohol and a hydrophilic vinylic monomer, a copolymer of glycerol (meth)acrylate with a hydrophilic vinylic monomer, a copolymer of 2,3,4-trihydroxybutyl (meth)acrylate and a hydrophilic vinylic monomer, a copolymer of 2,2-dihydroxypropyl (meth)acrylate and a hydrophilic vinylic monomer, a copolymer of 2,3-dihydroxybutyl (meth)acrylate and a hydrophilic vinylic monomer, a copolymer of glycerin-2 (meth)acrylate and a hydrophilic vinylic monomer, a copolymer of N-2,3-dihydroxypropyl (meth)acrylamide and a hydrophilic vinylic monomer, a copolymer of 3-allyloxy-1,2-propanediol and a hydrophilic vinylic monomer, or combinations thereof.

10. A method for producing coated silicone hydrogel contact lenses, comprising the steps of:
(1) obtaining a preformed silicone hydrogel contact lens, wherein the preformed hydrogel contact lens comprises a bulk silicone hydrogel material that comprises
(a) repeating units of at least one polysiloxane vinylic crosslinker and/or at least one siloxane-containing vinylic monomer,
(b) from about 0.5% to about 3.5% by weight of repeating units of at least one carboxyl-containing vinylic monomer,
(c) repeating units of at least one hydrophilic vinylic monomer,
(d) from about 2.5% to about 12.5% by weight of repeating units of at least one arylborono-containing vinylic monomer having an arylborono group, and
(e) optionally but preferably at least one non-silicone vinylic crosslinker; and
(2) heating the preformed silicone hydrogel contact lens in an aqueous coating solution at a temperature from about 60° C. to about 140° C. to form a coated silicone hydrogel contact lens comprising the bulk silicone hydrogel material and a non-silicone hydrogel coating thereon, wherein the aqueous coating solution comprises (a) at least one hydrophilic polymer having 1,2- and/or 1,3-diol moieties and (b) at least one water-soluble, thermally-crosslinkable hydrophilic polymeric material that is branched or slightly-crosslinked and comprises thermally crosslinkable groups and optionally reactive functional groups, wherein the thermally crosslinkable group are azetidinium groups and/or epoxide groups, wherein the reactive functional groups are primary amino groups, secondary amino groups, carboxylic acid groups, thiol groups, or combinations thereof, wherein the non-silicone hydrogel coating comprises a crosslinked polymeric material and a grafted hydrophilic polymer, wherein the crosslinked hydrophilic polymeric material is derived from said at least one water-soluble, thermally-crosslinkable hydrophilic polymeric material and is covalently attached to the bulk silicone hydrogel material through first linkages each formed between one carboxylic acid group and one azetidinium or epoxide group, wherein the grafted hydrophilic polymer is derived from said at least one hydrophilic polymer and is covalently attached to the bulk silicone hydrogel material through second linkages each formed between one arylboronoc group and one 1,2- or 1,3-diol moiety.

11. The method of claim 10, wherein the step of heating is performed preferably by autoclaving the preformed silicone hydrogel contact lens immersed in the aqueous coating solution in a sealed lens package at a temperature of from about 115° C. to about 125° C. for approximately 20-90 minutes, wherein the aqueous coating solution further comprises one buffering agents for maintaining a pH of from about 6.8 to about 8.5 and one ore more tonicity agents.

12. The method of claim 11, wherein the aqueous solution has a pH of from about 7.0 to about 8.2, wherein the aqueous solution comprises from about 0.01% to about 2% by weight of said at least one water-soluble thermally-crosslinkable hydrophilic polymeric material.

13. The method of claim 12, wherein the aqueous solution comprises a mixture of a monobasic dihydrogen phosphate and dibasic monohydrogen phosphate for maintaining the pH of the aqueous solution, wherein the the total concentration of the monobasic dihydrogen phosphate and the dibasic monohydrogen phosphate is at least 30 mM.

14. The method of claim 13, wherein said at least one diol-containing hydrophilic polymer comprises polyvinyl alcohol, poly(ethylene glycol)-graft-poly(vinyl alcohol), a copolymer of vinyl alcohol and a hydrophilic vinylic monomer, a copolymer of glycerol (meth)acrylate with a hydrophilic vinylic monomer, a copolymer of 2,3,4-trihydroxybutyl (meth)acrylate and a hydrophilic vinylic monomer, a copolymer of 2,2-dihydroxypropyl (meth)acrylate and a hydrophilic vinylic monomer, a copolymer of 2,3-dihydroxybutyl (meth)acrylate and a hydrophilic vinylic monomer, a copolymer of glycerin-2 (meth)acrylate and a hydrophilic vinylic monomer, a copolymer of N-2,3-dihydroxypropyl (meth)acrylamide and a hydrophilic vinylic monomer, a copolymer of 3-allyloxy-1,2-propanediol and a hydrophilic vinylic monomer, or combinations thereof.

15. The method of claim 14, wherein said at least one carboxyl-containing vinylic monomer is selected from the group consisting of acrylic acid, C₁-C₄ alkylacrylic acid, (meth)acrylox-C₁-C₆ alkanoic acid, mono-2-[(meth)acryloxy]-ethyl succinate, 2-acrylamidoglycolic acid, (meth)acrylamido-C₁-C₆ alanoic acid, and combinations thereof,
wherein said at least one arylborono-containing vinylic monomer is represented by formula (I) 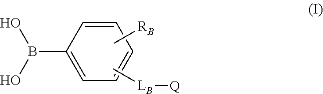
in which: R_{B} is a monovalent radical (preferably is H, NO₂, F, Cl, Br, CF₃, CH₂OH, or CH₂NR^{o}R^{o′} in which R^{o} and R^{o′} independent of each other are H or C₁-C₄ alkyl); Q is a monovalent radical of 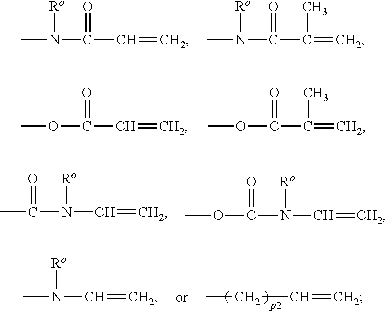
L_{B} is a direct bond, a C₁-C₄ alkylene divalent radical, a divalent radical of 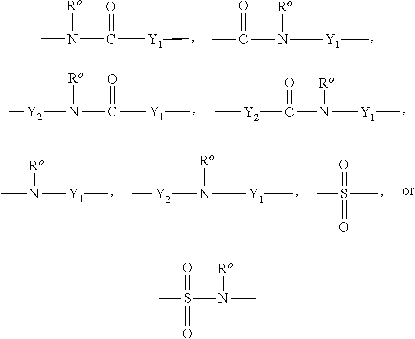
in which Y₁ is CH(OH) or a C₁-C₄ alkylene divalent radical, Y₂ is a C₁-C₄ alkylene divalent radical, p2 is an integer of 0 to 3, and R^{o} is H or a C₁-C₄ alkyl.

16. The method of claim 15, wherein said at least one water-soluble and thermally crosslinkable hydrophilic polymeric material comprises epoxide groups.

17. The method of claim 15, wherein said at least one water-soluble and thermally crosslinkable hydrophilic polymeric material comprises azetidinium groups.

18. The method of claim 15, wherein said at least one water-soluble and thermally crosslinkable hydrophilic polymeric material comprises: (i) one or more multi-armed polyethylene glycols each having terminal epoxide groups; (ii) a partial reaction product of a multi-armed polyethylen glycol having terminal epoxide group with one or more polyethylene glycol each having terminal functional groups selected from the group consisting of primary amine groups, secondary amine groups, carboxyl groups, thiol groups, and combinations thereof; (iii) a partial reaction product of a multi-armed polyethylene having terminal epoxide groups with a hydrophilicity-enhancing agent having at least one reactive functional group selected from the group consisting of amino group, carboxyl group, thiol group, and combination thereof; (iv) a partial reaction product of a copolymer of an epoxide-containing vinylic monomer and one or more hydrophilic vinylic monomer with a hydrophilicity-enhancing agent having at least one reactive functional group selected from the group consisting of amino group, carboxyl group, thiol group, and combination thereof; (v) a copolymer of an epoxide-containing vinylicmonomer, a hydrophilic vinylic monomer, and a C₁-C₄-alkoxy poly(ethylene glycol)ethyl (meth)acrylate having a number average molecular weight of up to 2500 Daltons, a poly(ethylene glycol)ethyl (meth)acrylate having a number average molecular weight of up to 2500 Daltons, a C₁-C₄-alkoxy poly(ethylene glycol)ethyl (meth)acrylamide, or a poly(ethylene glycol)ethyl (meth)acrylamide having a number average molecular weight of up to 2500 Daltons); or (vi) combinations thereof.

19. The method of claim 15, wherein said at least one water-soluble and thermally crosslinkable hydrophilic polymeric material is a three-dimensional network and thermally-crosslinkable groups within the network or being attached to the network.
